(19) United States
(12) Patent Application Publication
(10) Pub. No.: US 2011/0145141 A1
(43) Pub. Date: Jun. 16, 2011

(54) METHOD AND APPARATUS FOR RECHARGING ELECTRIC VEHICLES

(76) Inventor: James Blain, Northville, MI (US)

(21) Appl. No.: 12/969,716

(22) Filed: Dec. 16, 2010

Related U.S. Application Data
(63) Continuation of application No. 29/344,706, filed on Oct. 2, 2009, now Pat. No. D630165.
Application No. 29/344,706 is a continuation of application No. 29/344,705, filed on Oct. 2, 2009, now Pat. No. D631439.
(60) Provisional application No. 61/292,517, filed on Jan. 6, 2010.
(60) Provisional application No. 61/331,900, filed on May 6, 2010.
(60) Provisional application No. 61/386,022, filed on Sep. 24, 2010.

(51) Int. Cl. H02J 7/00; G06K 5/00; G06F 1/26; G06Q 40/00

(52) U.S. Cl. 705/39; 320/109; 235/382; 700/297

(57) ABSTRACT

An electric vehicle recharge station includes a housing with an outlet switchably coupled to an electrical electric power source. A vehicle connectible plug is removably mounted on the housing and connected to the outlet for supplying electric power from the outlet to the vehicle. The housing is mountable on top of a concrete pedestal embedded in the ground. The vehicle connectible plug is connected to the outlet by a coiled electrical cord. The housing supports two outlets and two J1772 plugs. A user interface communicates and receives instructions to and from the user via a touch screen display. The user interface provides selection of power charge time periods, stations on the housing, and payment. The housing can be configured for home use via a wall mount or as a wall mount for a parking garage.

### CROSS REFERENCE TO CO-PENDING APPLICATIONS

This application is a continuation-in-part of co-pending U.S. Design patent application Ser. No. 29/344,706, filed Oct. 2, 2009 and Ser. No. 29/344,705 filed Oct. 2, 2009, both in the name of James Blain and entitled “Electric Vehicle Recharge Station”, and claims priority benefit to the filing dates of co-pending U.S. Provisional Patent Application Ser. No. 61/292,517, filed Jan. 6, 2010; Ser. No. 61/331,900 filed May 6, 2010; and Ser. No. 61/386,022, filed Sep. 24, 2010, all in the name of James Blain and entitled “Method and Apparatus for Recharging Electric Vehicles”, the entire contents of all of which are incorporated herein by reference.

### BACKGROUND

The present invention relates, in general, to the electric vehicle electric power recharge stations.

Electric vehicles use electrical energy to propel the vehicle via electric motors coupled to the vehicle wheels. The electrical energy is stored in rechargeable batteries carried in the vehicle. The electric energy to recharge the vehicle batteries is supplied from an electrical outlet coupled to the electric utility power grid.

Vehicle recharge stations are typically employed to supply electrical charge from the electric grid through an electrical connector and conductor to the vehicle batteries. The battery charge capacity and the number of batteries that can be optimally mounted in a vehicle create limits that require the vehicle batteries to be frequently recharged when the vehicle is not in use. Such periods of vehicle non-use occur when the vehicle is parked at work, or at other locations in a parking spot or parking lot, or at home.

There is a need for vehicle recharge stations in all such locations. Some locations, such as work or in a parking lot, can provide free electric recharging or can provide electrical recharging at a user paid cost. Other locations, such as at home, can provide electric recharging as part of the user's home electric power consumption.

Thus, there is a need for electric vehicle recharge stations that are economical in manufacturing cost and are capable of various mounting configurations for widespread use in diverse locations as well as providing easy consumer use, connection and charging.

### SUMMARY

In one aspect, a vehicle recharge apparatus or station includes a housing, at least one electrical plug removably carried on the housing and connectible to a source of electric power through the housing, and a concrete pedestal mounted in the ground and supporting the housing. The housing is mounted on the top exposed end of the pedestal. An interactive touch screen display and a card reader are carried on the housing to facilitate use of the recharge apparatus.

One or two J1772 plugs are movably mountable on the housing and connected to the electric power source through the housing via coiled electrical conductors or cables. The plugs are removably attachable to a recharge connector on a vehicle.

In another aspect, a wall mount bracket is provided for mounting the housing to a wall. One or more conduit stubs and connectors are carried by one surface of the bracket to provide passageways for electrical power conductors and network conductors into the housing.

In another aspect, a user interface, implemented on a computer machine, is provided for controlling this supply of electric power to a vehicle via a plug-in connection. The method comprises the steps of providing an electric power control device coupled to a source of electric power, providing at least one power outlet on the electric power control device electrically connected to a connector adapted for electrical connection to an electric rechargeable vehicles, providing a visual user interface operated by the control device to display instructions to the user for connecting a plug to the at least one outlet and for validating a user's access to electric power through the control device, the user interface providing, requesting the user to connect a plug from a vehicle to the at least one outlet, offering selectable electric power supply time increments to the user; accepting a time increment selected by the user; validating the user's access to the selected supply time increment, connecting electric power from the electric power source through the control device, the outlet and the plug to the vehicle for the duration of the selected supply time increment, and discontinuing the supply of electric power to the vehicle at the end of the selected supply time increment.

The step of validating the user comprises the steps of receiving payment instructions from the user through the user interface and processing the payment instructions before starting the supply of electric power through the control device.

The user interface method can provide either an unrestricted mode of operation, which does not require payment for electric power, and an authorized card mode of operation requiring verification of a user card for charging electric power used at selected electric power rates to a user account associated with the card.

### BRIEF DESCRIPTION OF THE DRAWING

The various features, advantages and other uses of the present method and apparatus for recharging electric vehicles will become more apparent by referring to the following detailed description and drawing in which:

FIG. 1 is a perspective view of one aspect of a vehicle recharge station;

FIG. 2 is a front elevational view of the recharge station shown in FIG. 1;

FIG. 3 is a side elevational view of the recharge station shown in FIG. 1;

FIG. 4 is a rear elevational view of the recharge station shown in Fig.;

FIG. 5 is a perspective view of the internal frame structure of the recharge station shown in FIG. 1;

FIG. 6 is a perspective view of the rear exterior cover of the recharge station shown in FIG. 1;

FIG. 7 is a perspective view of the front cover of the recharge station shown in FIG. 1;

FIG. 8 is a cross sectional view generally taken along line 8-8 in FIG. 2;

FIG. 9A is a cross sectional view generally taken along line 9-9 in FIG. 11;

FIG. 9B is a cross-sectional view of pedestal generally taken along lines 9B-9B in FIG. 3;

FIG. 10 is a cross sectional view generally taken along line 10-10 in FIG. 2;

FIG. 11 is a cross sectional view generally taken along line 11-11 in FIG. 2;

FIG. 12 is a circuit and block diagram of the recharge station shown in FIG. 1;

FIG. 13A-13L are pictorial representations of the user interface used in the aspect used in the recharge station shown in FIG. 1;

FIG. 14 is a block diagram depicting the operation of the station in an unrestricted mode of operation;

FIG. 15 is a block diagram depicting the operation of the station in an access card/credit card mode of operation;

FIG. 16 is a perspective view of a wall mount recharge station including the recharge station housing shown in FIG. 1 mounted on a wall mounting bracket;

FIG. 17 is a side elevational view of the recharge station shown in FIG. 16;

FIG. 18 is an enlarged, side elevational view of the mounting bracket shown in FIG. 17;

FIG. 19 is a front elevational view of the mounting bracket shown in FIGS. 17 and 18;

FIG. 20 is a perspective view of a home mounted vehicle recharge station;

FIG. 21 is a perspective view of another aspect of a recharge station showing side mounted connection plugs;

FIG. 22 is a block diagram of the single board computer board;

FIG. 23 is a circuit diagram of the surge protection circuit;

FIG. 24 is a circuit diagram of one power stage circuit;

FIG. 25 is a block diagram of the IO board;

FIG. 26 is a circuit diagram of the AC voltage measurement circuit on the IO board;

FIG. 27 is a circuit diagram of the AC current measurement circuit on the IO board; and

FIG. 28 is circuit diagram of the leakage current detection circuit on the IO board.

### DETAILED DESCRIPTION

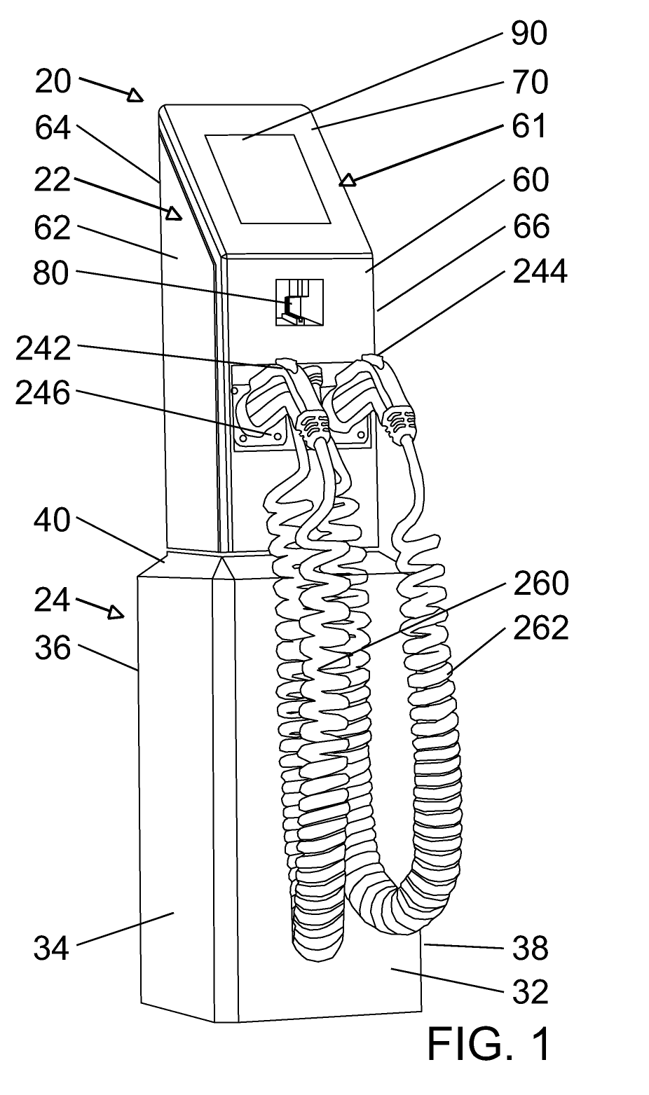

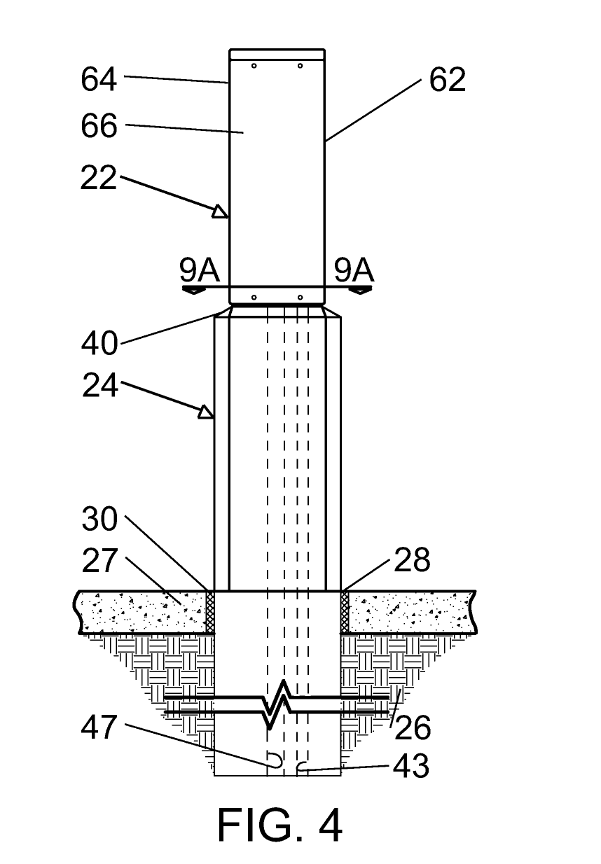

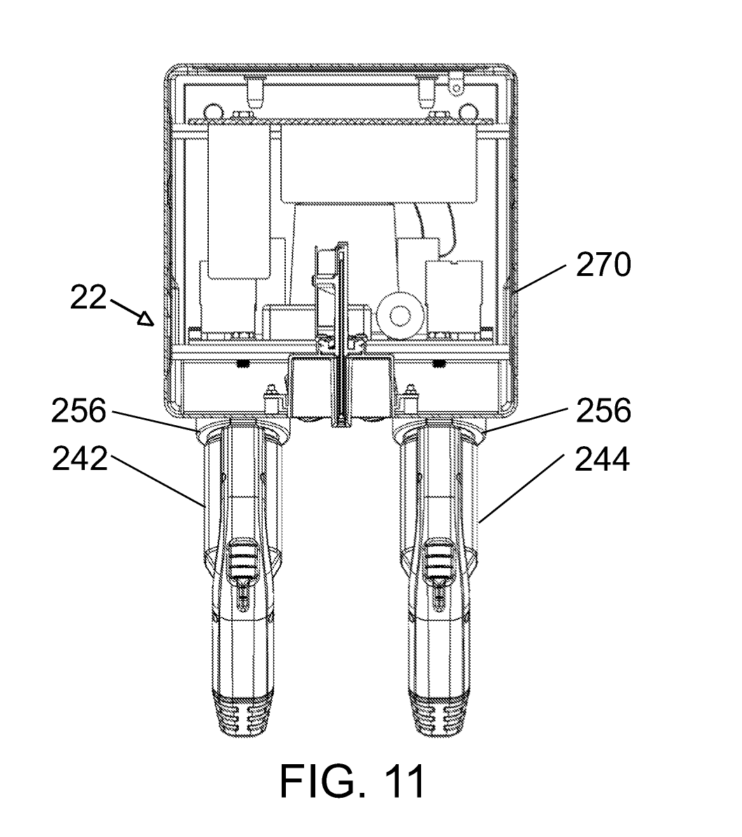

Referring now to FIGS. 1-15 there is depicted one aspect of vehicle recharge station 20. The station 20 includes a housing 22. The housing 22 has a generally square cross-section configuration, by way of example only. The housing 22 has a first wall 60, hereafter designated as the front wall, for description purposes only. The housing 22 also includes one sidewall 62, a rear wall 64, and an opposed sidewall 66. The walls 62, 64 and 66 have predetermined lengths and, in the case of the sidewalls 62 and 66, angled ends to receive a top wall 70 at an easy viewing and use angle.

The housing 22 is preferably formed of a weather resistant, non-corrosive material, such as a metal, i.e., stainless steel.

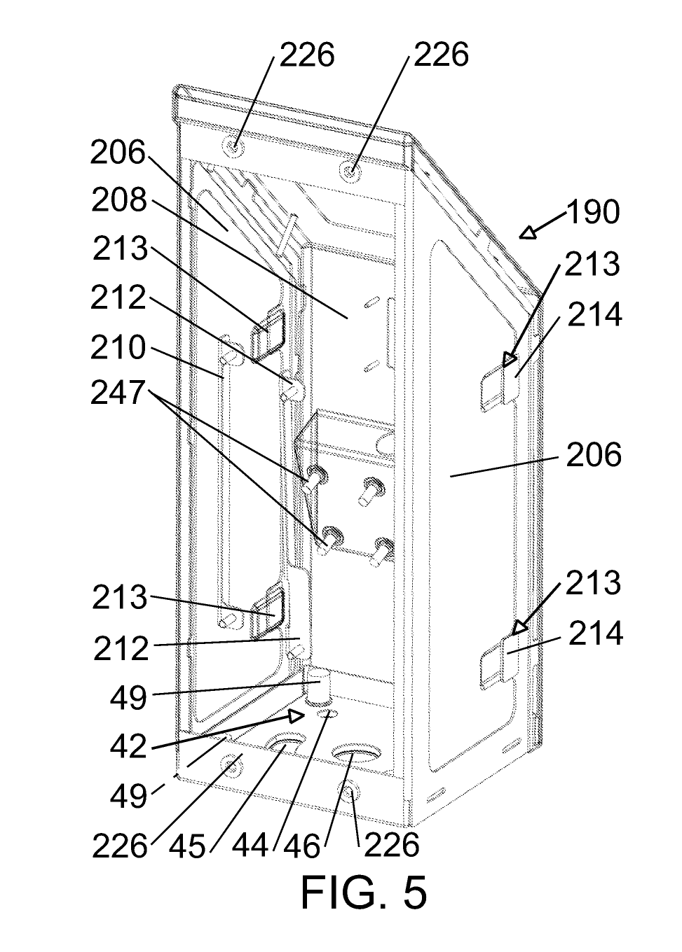

The vehicle recharge station 20 includes an internal frame or support structure 190, shown in FIGS. 5, 8, 10 and 11. The frame 190 has an integral three sided construction formed of a pair of spaced sidewalls 206 and a central wall 208. The rear surface of the frame 190 opposite the front wall 208 is open. A pair of vertically extending straps 210 and 212 are attached such as by welding for example, to each sidewall 206 of the frame 190. Flanges on the straps 210 and 212 serve as mounting locations for threaded fasteners to mount AC and DC circuit boards, as described hereafter to the frame 190.

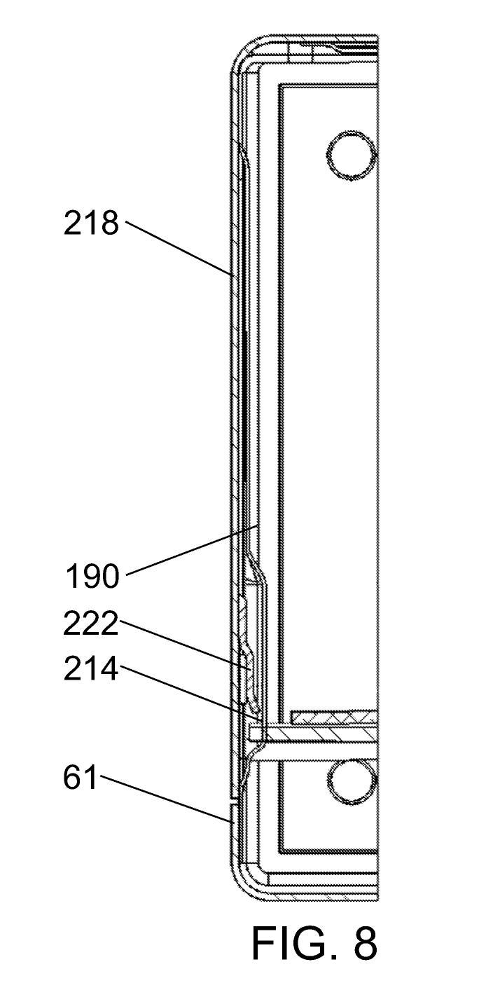

As shown in FIGS. 5 and 8, a plurality, such as four, for example, of stamped or formed inserts 213 are located near the front and rear corners of the sidewalls 206 of the frame 190. Each insert 213 carries an interlock strap 214 which mates with tabs on the front and rear portions of outer housing covers as described hereafter to the frame 190.

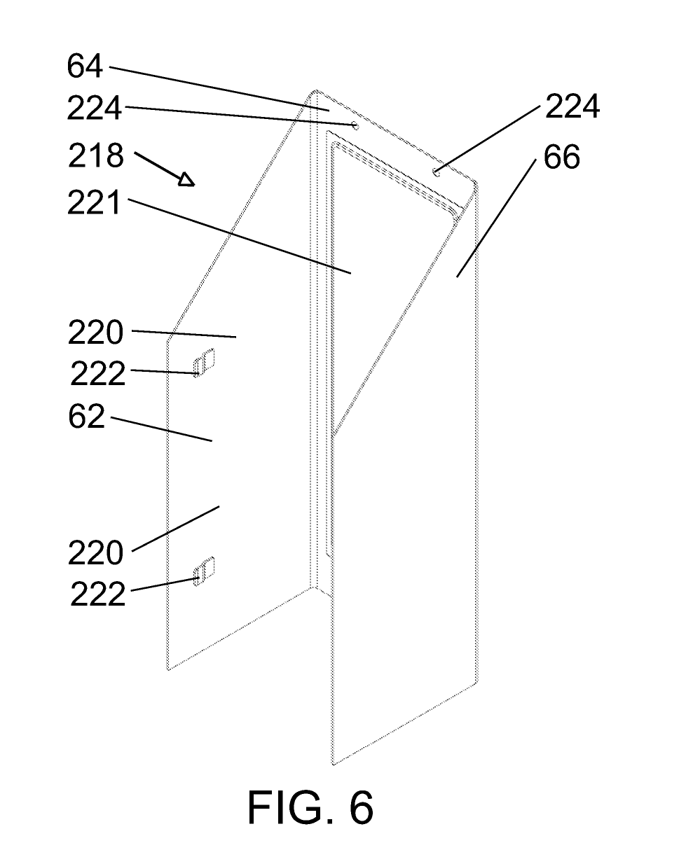

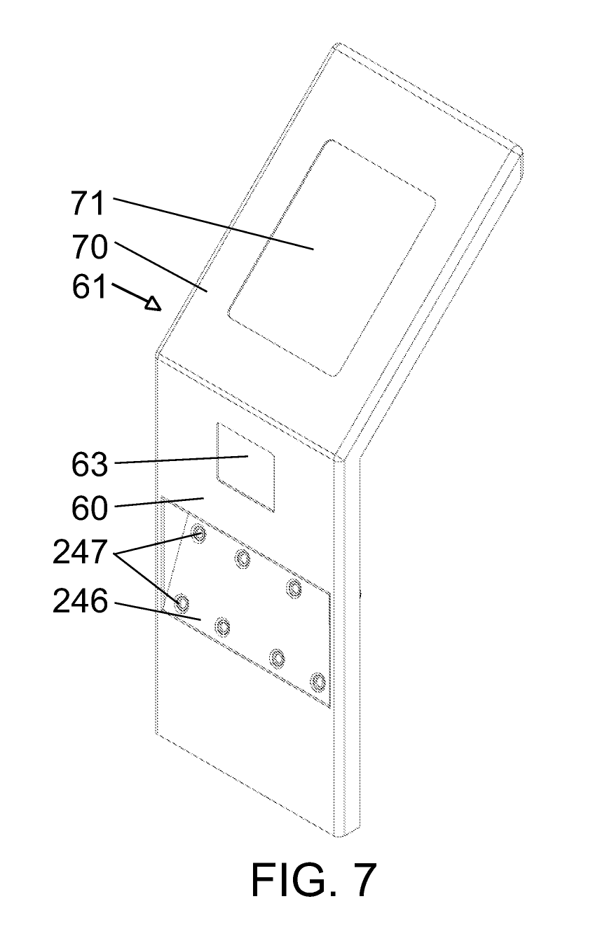

Referring now to FIGS. 6 and 7, the housing 22 includes a one-piece rear outer cover 218 that includes the sidewalls 62 and 66 that are joined at one end by the rearwall 64. As shown in FIG. 6, the sidewalls 62 and 66 have an angled upper edge to accommodate the angled top wall 70 of the front wall 60.

A plurality of mounting tabs or clips, all denoted by reference number 220, are mounted adjacent the front edges of the sidewalls 62 and 66, with two tabs 220 on each sidewall 62 and 66. Each mounting tab 220 has one end secured by welding or fasteners to the sidewalls 62 or 66 and an opposed outwardly bent end 222, which is spaced from the inner surface of the sidewalls 62 and 66 as shown in detail in FIGS. 6 and 8. When the rear outer cover 218 is mounted on the internal frame 190, the ends 222 of the mounting tabs 220 engage and interlock with the interlock straps 214 carried on the internal frame 190 to position and mount the rear cover 218 on the internal frame 190.

A plurality of apertures 224 are formed at opposed corners of the rearwall 64 of the rear cover 218, as shown in FIG. 6. The apertures 224 align with a plurality of sockets 226 such as four in the present example, which extend inward from a thin edge flange at the rear of the frame 190, as is shown in FIG. 5. The sockets 226 have an internal bore extending from an open end in the rear of the frame 190 and receive a tamper proof screw 228, which extends through the aperture 224 in the rearwall 64 of the rear outer cover 218 into the bore in the socket 226 to securely attach the rear outer cover 218 to the frame 190. With appropriate tools, the tamper proof screws 228 can be removed to enable the rear outer cover 218 to be separated from the internal frame 190 for servicing the internal components of the recharge station 220.

An electrical insulator panel 221, FIG. 6, is affixed, such as by fasteners or welded tabs, to the rearwall 64 of the rear cover 218.

The front outer cover 61 is shown in FIG. 7. The front cover 61 includes the front wall 60 and the angled upper wall or surface 70. The front wall 60 and the angled upper surface 70 have depending side flanges which overlap surfaces on the frame 190 and allow the front cover 61 to be welded or otherwise secured to the frame 190.

As shown in FIG. 7, the front wall 60 includes an aperture 63 which allows access to a card reader as described hereafter. The angled upper surface 70 also includes an aperture 71 which allows access to and visibility of a display as also described hereafter.

The housing 22 is securely attached to a base or pedestal 24 which is securely mounted in the ground 26 as shown in FIGS. 1-4. Within the meaning of the use of the recharge station 20, the ground 26 may constitute any ground surface, including soil. However, in most cases, the ground surface will include a layer of concrete 27, such as a sidewalk, parking lot, street surface, etc., or a layer of asphalt mounted over a suitable asphalt base, all disposed over an underlying depth of soil.

The base 24 is typically formed of concrete. A SONOTUBE™ concrete pedestal construction maybe employed to form the base 24. By way of example only, the base 24 is depicted as having a generally square configuration with sidewalls 32, 34, 36 and 38. Other shapes may also be employed for the base 24.

The base 24 has a length suitable to extend a predetermined distance below the surface 27 sufficient to meet local building frost depth codes. For example, the lower end 25 of the base 24 may extend three feet or more into the ground 26 below the surface layer 27.

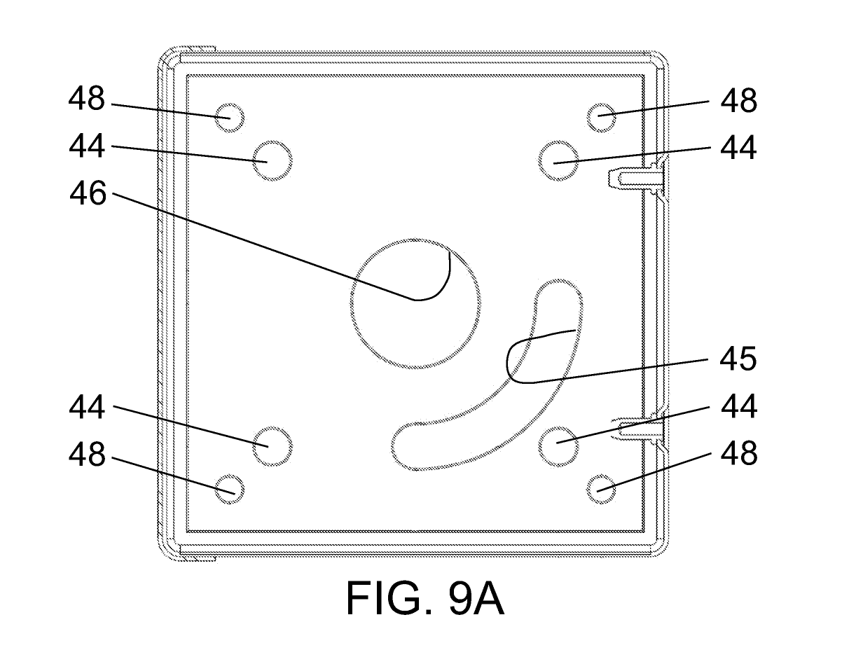

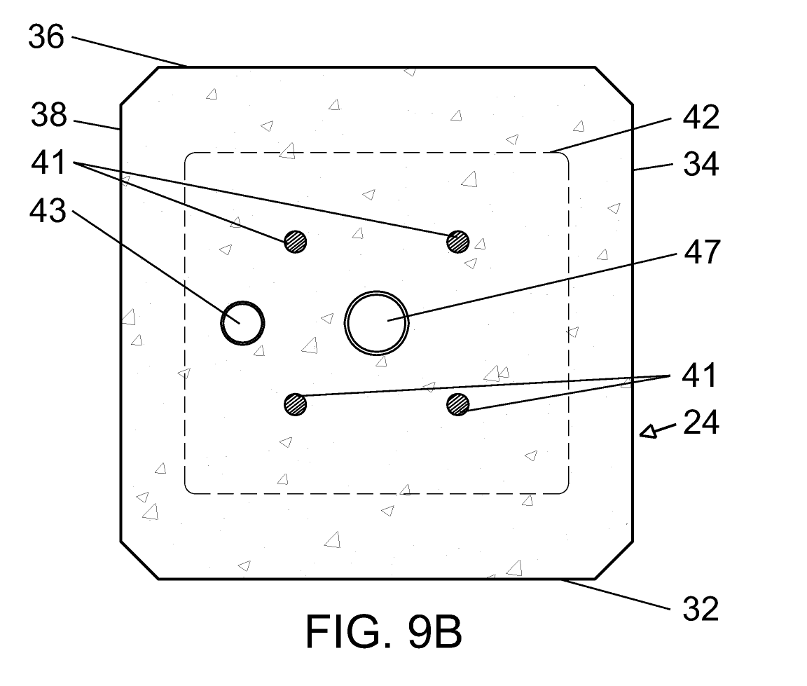

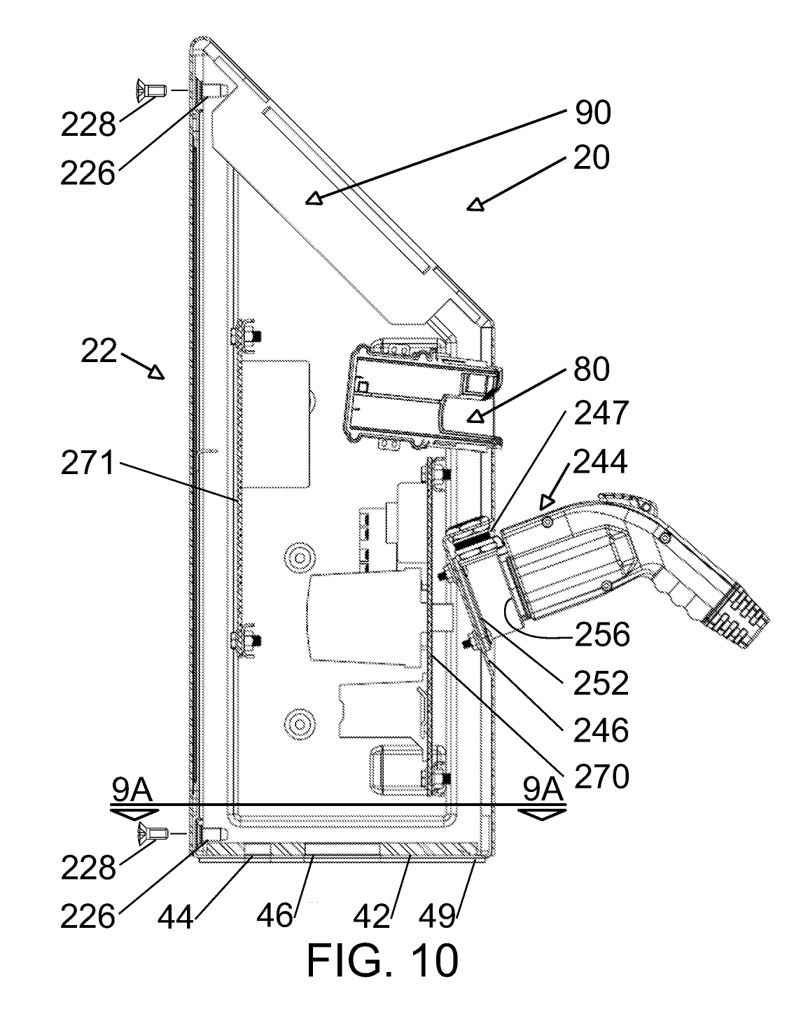

A layer of concrete paper 30 maybe interposed in an opening 28 in the surface layer 27 to seal the base 24 within the opening 28 in the surface layer 27. The top edge 40 of the base 24 may have an inward angled shape, as shown in FIGS. 1-4 and receives a mounting plate 42 shown in FIGS. 9A and 10 fixed within the bottom end of the frame 190 by suitable fastening means, such as welding, fasteners, etc.

The mounting plate 42 is preferably formed of a metal, such as steel or stainless steel. The plate 42 includes a plurality of mounting apertures, such as two sets of four apertures 44 and 48. Rebar rods 41 may be fixed within the cement of the base 24 and extend upward from the top surface of the base 24 to extend through the apertures 48 in the mounting plate 42. The upper ends of the rebar rods 41 may be threaded to receive nuts 49 as seen in FIG. 5 to fix the mounting plate 42 and the attached frame 190 in the housing 22 of the recharge station 20 on the upper end of the base pedestal 24.

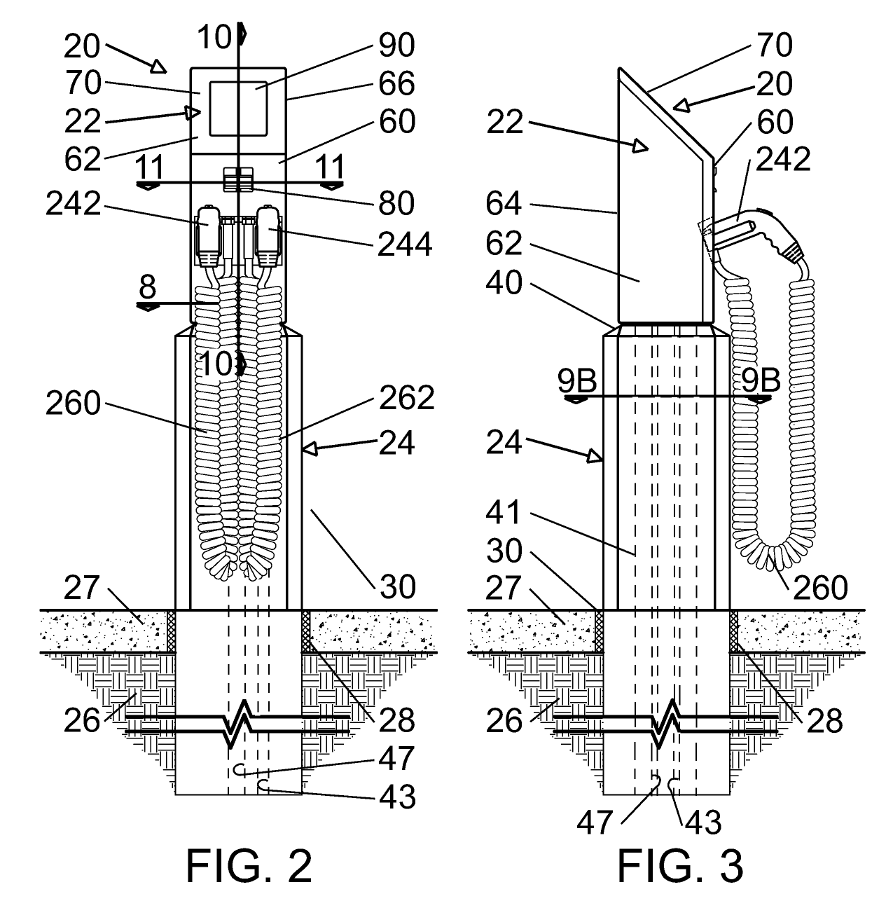

A central aperture 46 is formed in the plate 42 to provide access to a conduit or bore 47, shown in FIG. 2, which extends through the entire length of the base 24 and opens through the lower end 25 of the base 24 to provide access for the power line conductors to supply 240V AC electric service to the recharge station 20. An elongated slot 45 is formed in the plate to provide access to a conduit 43 running through the base 24 which carries a network or Ethernet cable.

A silicone or rubber gasket 49, shown in FIG. 10 with apertures complementary to the positions of the apertures 44, 45, 46, and 48 in the plate 42 maybe interposed between the plate 42 and the top surface of the base 24.

The concrete pedestal 24 provides a secure base for the housing 20 while preventing accidental contact with and damage to the housing and the electrical components and power conductors mounted within the housing by a vehicle when the vehicle is being parked next to the recharge station 20 without requiring separate bollards which could inhibit user access to the recharge station 20. At the same time, the concrete pedestal 24 enables easy access by the user to the display 80 and the vehicle power coupling plugs.

As shown in FIGS. 1 and 2, a card reader 80 is mounted in the frontwall 60 of the housing 22. The card reader 80 is a standard credit or access card reader, such as one manufactured by Sankyo (Nidec Sankyo America Corporation), Shelbyville, Ind. as model # ICM350-3R1395. The card reader 80 is a standard credit or access card reader. The card reader 80 reads data carried on a card inserted into a card reader slot and provides wireless or wire communication to a card reader processor for verifying customer information, billing, etc.

A display 90 is mounted in the top wall 70 of the housing 22. The display 90 can be a touch screen display providing interactive communication with a customer. The display 90 is driven by a central processing unit 100 as described hereafter.

In this aspect, the recharge station 20 includes two J1772 plugs 242 and 244, which are mounted in receivers carried in a recessed panel 246 on the front wall of the housing 22. As shown more clearly in FIGS. 7 and 10, a panel 246 is mounted in an angular orientation in the front wall 60 of the housing 22 to form a recess 247. The panel 246 lies out of the major plane of the front wall 60 of the housing 22.

A pair of plug receivers 248 and 250 is mounted on the panel 246. Each receiver 248 and 250 includes a base plate 252 which has plurality of mounting apertures for receiving fasteners 254 to fix the base plate 252 to threaded sockets 247 on the panel 246. The receivers 248 and 350 each include a generally cylindrical sleeve 256 fixed to each base 252 which extends outward from the respective base plate 252. Each sleeve 256 has a socket with a plurality of open-ended bores complimentary shaped and positioned to the pins in the J1772 plug 242 or 244 so as to removably receive and support one end of one of the J1772 plugs 242 and 244 in a non-use position shown in FIGS. 1, 10, and 11.

A pair of cord connectors 260 and 262 is also mounted on the panel 246 generally in-between the two base plates 152 for the two J1772 plugs 242 and 244. The connectors 260 and 262 can be liquid tight cable strain relief type fittings which allow one end portion of an electrical 264 or 266 to pass therethrough to electrical connections within the interior of the housing 20. The other end of the cords 264 and 266 are connected to one of the J1772 plugs 242 or 244, respectively.

The cords 264 and 266 may be any type of electrical conductor cable. By way of example, the cords 264 and 266 are in the form of coiled cords. This provides cable management for the cords 264 and 266, which maintains the cords 264 and 266 closely proximate to the recharge station 20 when the J1772 plugs are in the non-use position mounted in the receivers 256. The coiled nature of the cords 264 and 266 also maintain the lower end of the cords 264 and 266, at or above the ground surface, which aids in maintaining the integrity and cleanliness of the cords 264 and 266 since the cords 264 and 266 are not laying on the ground surface or in the parking area for the vehicle immediately adjacent the recharge station 20. At the same time, the expandable nature of the coiled cords 264 and 266 enables the J1772 plugs 242 and 244 to be easily removed from the receivers 256 in the housing 22 and extended to engage the plug socket in the vehicle, regardless of the location of the plug socket on the vehicle.

As shown in FIG. 10, a circuit board 270 is mounted interiorly behind the front of the frame 190 on the straps 210 and 212 and carries the AC power and control components, such as the AC contactors, ground fault detector, current transformers, AC surge protector and AC busses of the recharge station 220. A second circuit board 271 is mounted on the rear wall 54 of the frame 190 and supports the DC power components, such as the DC power supply and the central processing unit or CPU/or of the recharge station 20.

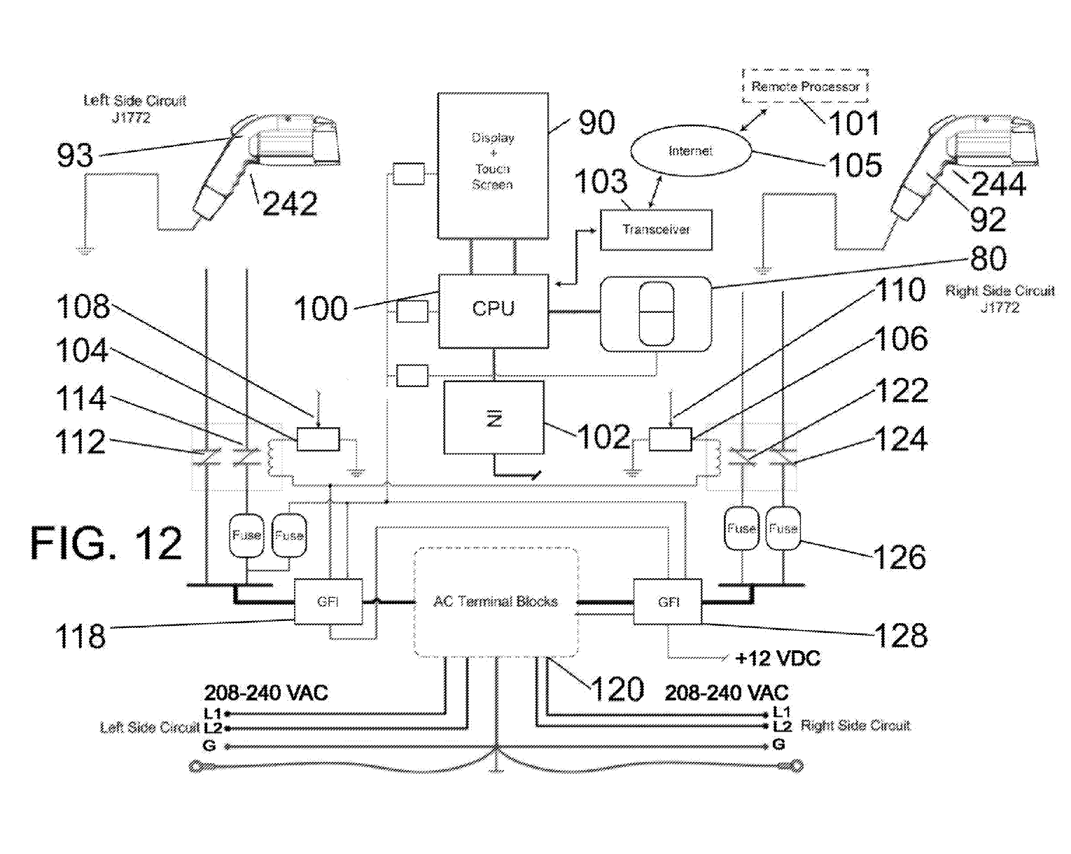

A circuit diagram of the various components mounted within the housing 20 is shown in FIG. 12. The processor or central processing unit CPU 100, shown in FIG. 12, is mounted on the circuit board 271. The CPU 100 provides control signals to the display or touch screen 90 via VGA and/or USB connections. Similarly, the card reader 80 is coupled through a USB port to the CPU 100. An optional circuit board 102 is provided for conditioning input and output signals to and from the CPU 100.

First and second AC. contactors 104 and 106 are provided in the housing 20 and receive control signals 108 and 110, respectively, from the CPU 100 which control the activation and deactivation of the contactors 104 and 106.

The first contactor 104 controls two switchable contacts or outlets 112 and 114 connected at the L1 and L2 power conductors extending to the second plug 243. The other sides of the contacts 112 and 114 are connected through fuses 116 and a ground fault interrupter 118 to terminals in an AC terminal block 120 which receive 200/240 VAC power conductors.

Similarly, the second contactor 106 controls separate contacts 122 and 124 coupled through individual fuses 126 and a ground fault interrupter 128 to terminals in the AC terminal block 120 for coupling 208-240 VAC line power on lines L1 and L2 to the J1772 plug 244.

Also shown in FIG. 12 is a remote communication link between the central processor 100 and a remote processor or data center 101. A communication link is established between the processors 100 and 101. In one example shown in FIG. 12, the communication link includes radio frequency transceiver 103 which is capable of bi-directional communication through the Internet 105 between the remote processor 101 and the central processor 100 in the vehicle recharge station. At least a portion of the communication link between the transceiver 103 and the remote processor 101 may include wireless communication via HTTP. Alternately, the communication link between the transceiver 103 and the remote processor 101 may include a hard wired carrier network, satellite links, as well as other communication paths.

The remote processor 101 maybe part of a central data center which is placed in bidirectional communication with the CPU OR processor 100 in the recharge station to monitor the operation of the recharge station, run diagnostics on the recharge station, generate recharge station power usage reports, adjust the billing rate for power consumed through the recharge station, as well as altering the screen display 90 for displaying advertising, different user instructions or use information, etc.

The CPU 100 executes a stored software program, which controls the operation of the vehicle recharge station 20.

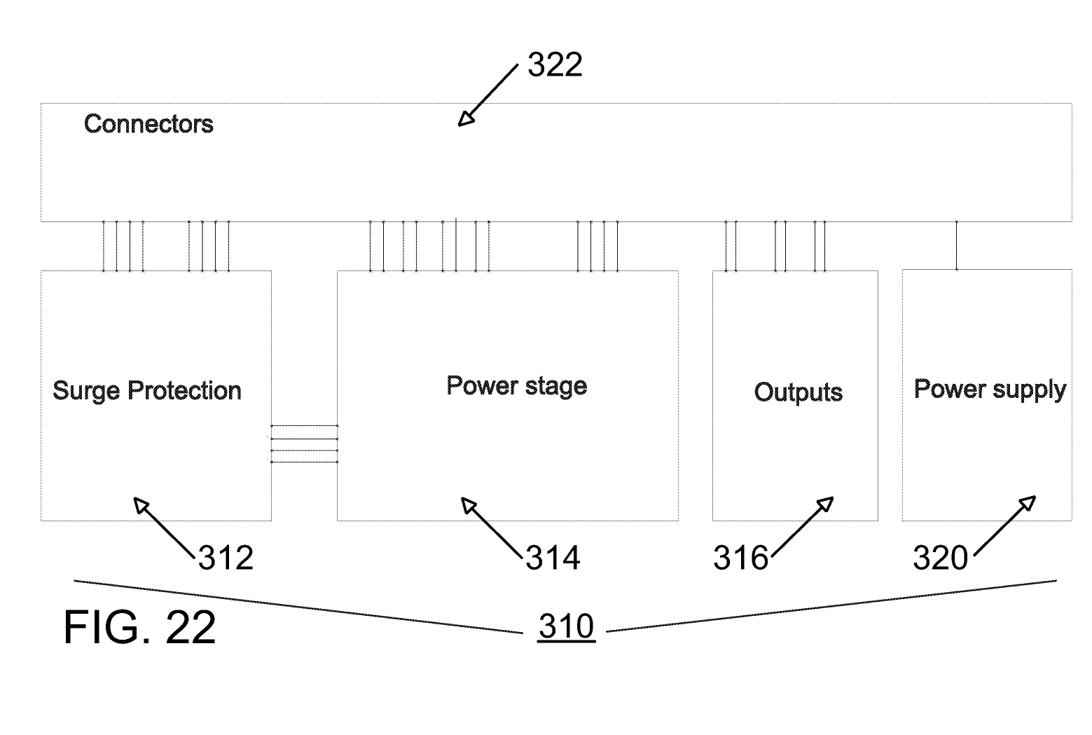

Referring now to FIGS. 22-28, there are depicted circuit and block diagrams of the power control components of the station 20. The power control board 310 includes various functional circuits, such as a surge protection circuit 312, a power stage circuit 314, an output stage 316 and a power supply 320.

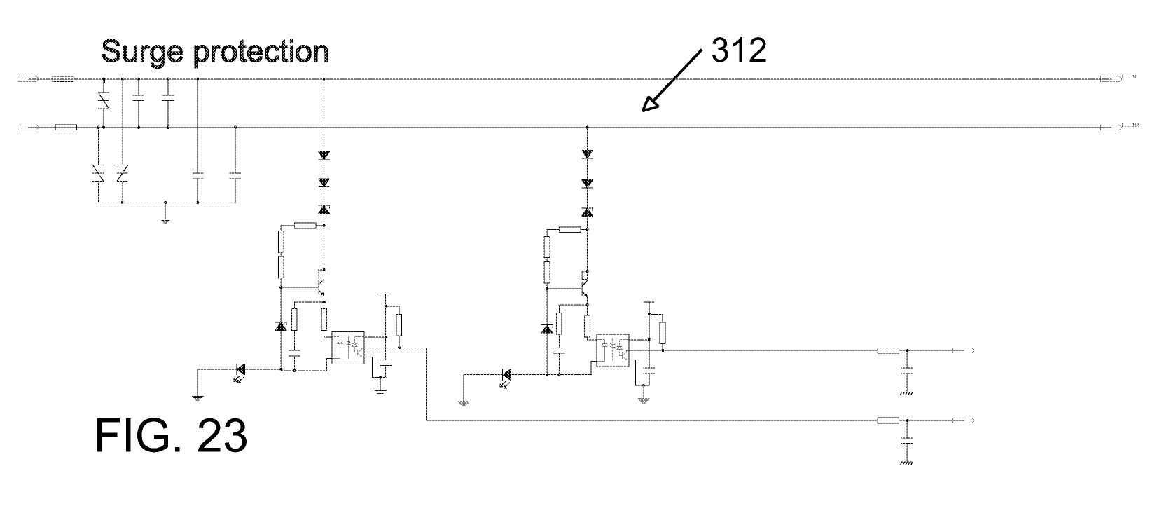

The surge protection circuit 312 is depicted in FIG. 23. Functionally, the surge protection circuit 312, which is duplicated for each of the J1772 plugs 242 and 244, detects over voltage spikes on the incoming AC power line conductors. It will absorb or divert the over-voltage spikes from the remaining circuitry.

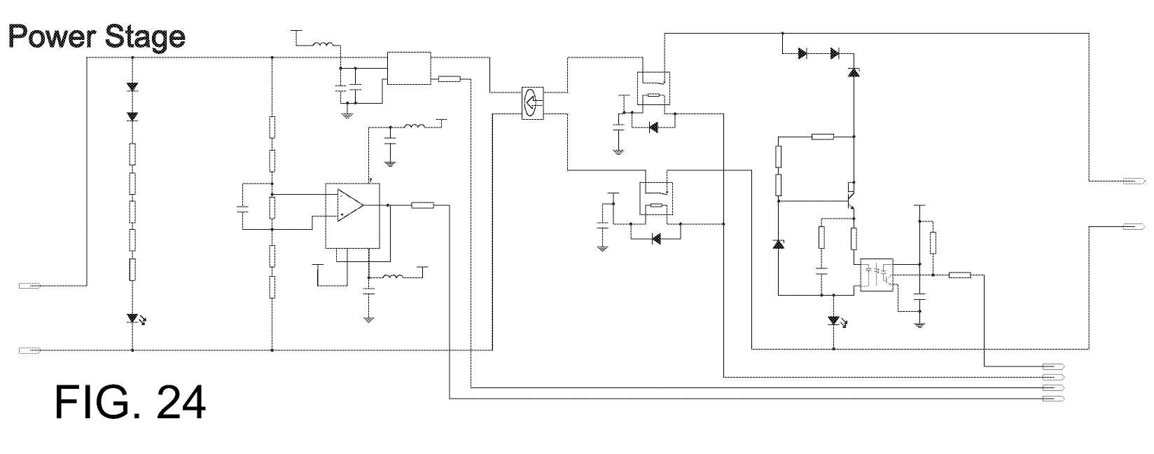

The power stage circuit 314 is shown in FIG. 24. This circuit 314, under the control of the CPU 100, as described hereafter, functions to control the state of the contactors 104 and 106 between on and off states.

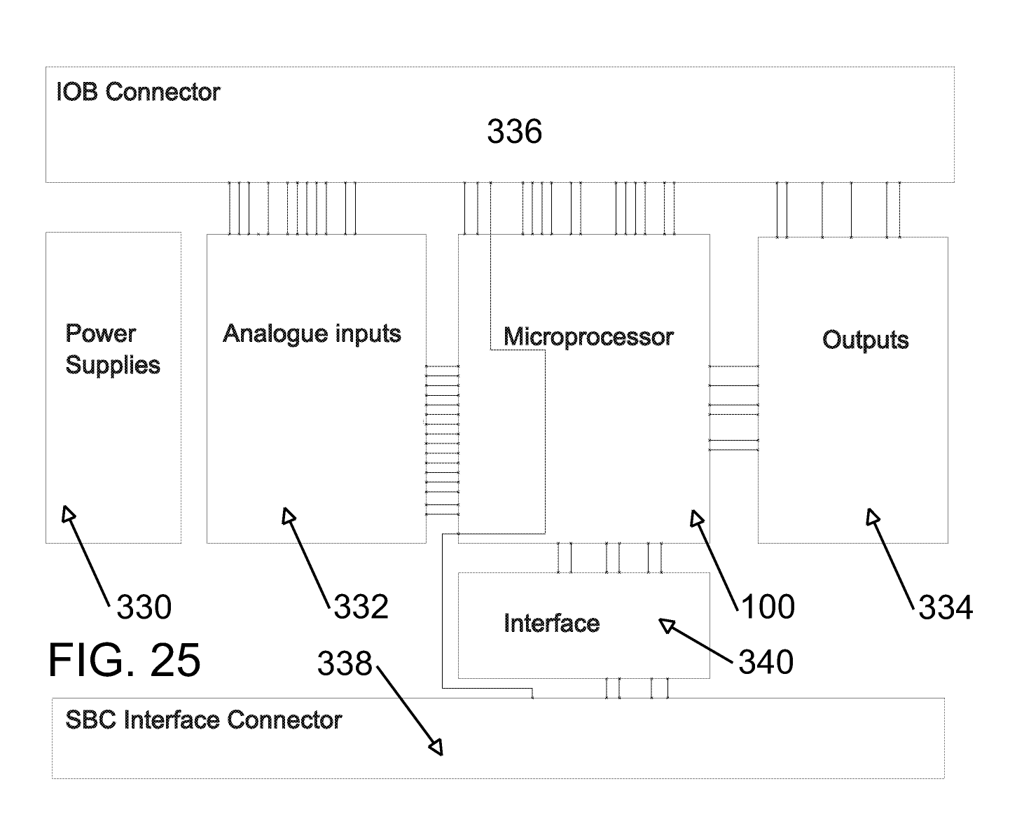

The functional block diagram and circuits of the IO board as shown in FIGS. 25-28.

Generally, the IO board includes the central processing unit 100, in the form of a microprocessor, power supply 330, an analog input circuit 332, an output circuit 334, connectors 336 and an SBC interface connector 338 and interface 340.

The CPU 100 is formed, for example, with a commercially available single board computer (SBC) and a second separate IO processor. The SBC controls the display 90, the network connections and communicates with the IO processor. The IO processor controls the state of the contactors 104 and 106, the current and voltage measurement and the system safety controls.

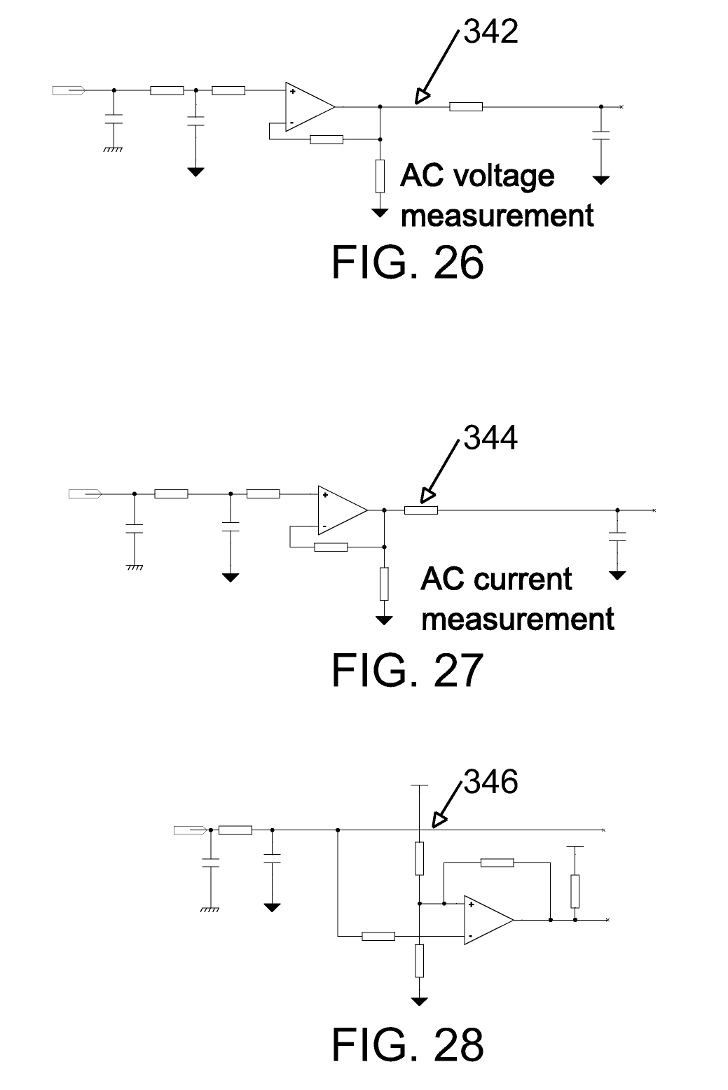

FIGS. 26 and 27 respectively depict an AC voltage measurement circuit 342 and an AC current measurement circuit 344 which are used to provide voltage and current measurements during the supply of electric power to the vehicle.

FIG. 28 depicts one of two leakage current circuits 346. The leakage current circuit 346 constantly monitors leakage currents during the supply of electric charge to the vehicle. The leakage current is part of the ground fault interrupt circuit on the AC board which determines the amount and duration of leakage current necessary for condition to shut down the supply of electric charge to the vehicle a fault.

Communication flow control is based on the “Master-Slave” control communication. The SBC is a “Master” and IOB is a “Slave”. The SBC always starts communication transaction and keeps the correctness of delivering reports, resending corrupted packets and controls functionality of JOB.

To keep the actual measurements and states of the JOB, the SBC continuously transmits “GET” packages as quick as possible and receives “ACK” packages with required information. The “GET” package can combine some addresses of variables to reduce communication overhead. The IOB always waits for request from the SBC and either replies with “ACK” package if the received package was correct or “NAK” package if the received package was corrupt (bad CRC, incorrect data, etc.). If the SBC does not get a “ACK” packet after “X” retries, the SBC reports a loss of communication error.

The SBC can send a “PUT”: type of package to transmit the controlling data into JOB. This package also can combine some addresses of variables that minimize data delivery time. The IOB will acknowledge this package through sending empty “ACK” package as well. If the SBC does not get “ACK” packet after “X” retries, the SBC reports loss of communication error.

The SBC and IOB keep internal counters to inform each other about its operability. The SBC interlaces the general communication with “PUT” packet to inform the IOB about actual state of its rolling counter and requests the IOB through sending “GET” packet to get actual state of IOB rolling counter. The “PUT” packet of SBC is acknowledged by the IOB with empty “ACK”: packet and the “GET” packet from SBC is acknowledged with “ACK” packet that includes the IOB rolling counter data.

If the incorrect counter of SBC was received by the IOB, then the IOB replies with “NAK” packet that forces the SBC to resend the same packet again. If the incorrect counter of IOB was received by the SBC, then the SBC resends the same request again. If the SBC does not receive the correct number after “X” retries. it reports a loss of communication error. If SBC does not get an “ACK” packet, this means that the expected value of counter was not received by the IOB and after “X” retries, the SBC reports a loss of communication error as well.

If no response is received (positive nor negative) within “X” ms timeout, then the master/sender shall retry to send the command again. If the master/sender does not get any answer after “X” retries, it report s a loss of communication error.

Each variable has a single node defined as a source. Both nodes will have a copy of each variable. The source node is the node that calculates the value of the variable. A node that is defined as the source for a variable can update the value of the variable on the other node via PUT packet. The node that is not the source of a variable can update the local value of the variable via a GET packet. As defined below for each variable, the source node will PUT the value to the other node at the specified rate. The destination node can GET the latest value at any time.

The variables can include: Contactor #1 State, Contactor #2 State, CCID #1 State, CCID #2 State, AC Current #1, AC Current #2, AC Voltage #1, AC Voltage #2, CCID #1 Leakage Current, CCID #2 Leakage Current, J1772 Pilot #1, J1772 Pilot #2, Service Ground Integrity Status, DC Supply Voltage, Interior Temperature #1, Interior Temperature #2, Surge Protector Status, Activate Charging #1, Activate Charging #2, Set J1172 Pilot #1 PWM, Set J1772 Pilot #2 PWM, IO Board Rolling Count, and SBC Rolling Counts.

The IO board determines the state of the contactors 104, 106 based on the status of the voltage present signals and the contactor commands. In the event that the contactors 104, 106 do not open or close as commanded, one of the error states will be set to indicate that the contactors 104, 106 are stuck open or closed.

The user interface application will use the contactor state to determine the correct user interface screen and display content.

The I/O board will determine the state of each CCID based on the status of the ground fault monitor alarm signal. An alarm signal indicates that the differential current level has exceeded a predetermined level and the circuit has been interrupted.

If a fault has occurred, the I/O board software may attempt to rest the CCID a limited number of times. The corresponding state will be set to indicate if reclosure attempt is available, the maximum number of reclosure attempts has been reached, or reclosure is not available.

When the user interface application determines that the user has requested to activate charging, it will set this value to TRUE. This variable should remain TRUE as long as the application determines that charging functionality is requested.

When the user interface application determines that the user has not requested to activate charging, it will set this value to FALSE. This variable should remain FALSE as long as the application determines that charging functionality is not requested.

While the I/O board software reads this variable as TRUE, the I/O board software will read the J1772 Pilot state, and transmit the J1772 Pilot PWM signal if the corresponding state(s) are active. As long as the PWM signal is being transmitted, the I/O board software will be prepared to open or close the contactors based on the feedback from the J1772 Pilot state.

The I/O board measures the charging current for each charging circuit and provides this value to the user interface application for information purposes. This value can be used for power calculation and central monitoring functions.

The I/O board measures the voltage for each charging circuit and provides this value to the UI application for information purpose. This value can be used for power calculations and central monitoring functions.

The I/O board measures the CCID leakage current and uses this for information purposes.

The I/O board will report the state of the J1772 pilot signal. The user interface application uses the J1772 pilot state.

The I/O board measure the DC supply voltage and uses this for information purposes.

The I/O board uses the temperature sensor signals to monitor the internal temperature of the PEP station. If a temperature signal value exceeds the allowed limits, the I/0 board will open the contractors and disable charging until the temperature value falls below a predefined value for a certain period of time. The user interface application will use the temperature signals.

The I/O board will use the surge protector status signal to determine whether a fuse has blown due to a power surge. If a fuse is blown, this signal will be set to TRUE. Under normal operation it will be set to FALSE. The I/O board software will prevent the contactors from closing if this signal indicates that the surge protection has failed.

The J1772 pilot PWM duty cycle will determine the charge current limit. The user interface application will determine this value.

To ensure the both applications are running correctly a communications watchdog mechanism is used. The SBC rolling count and IO board rolling count variables are used for this. For each of these variables the value will increment by one each time it is sent and wrap to zero on overflow. Either node will signal a communications fault to the application if the received variable values do not increment sequential or if the variable is not receive at the specified rate.

The rolling count variable will be transmitted at a frequency of 1 H_{z}. A loss of communications will occur if the SBC does not receive an acknowledgment from the IO board within “x” seconds of transmitting the rolling count.

If either node determines that the received count from the other node does not match its own node, an error count will be incremented. If the error count is greater than 0 and counts from each node match, the error count will be decremented by 1. If any time the error count is greater than TBD, a loss of communications has occurred.

The software architecture includes main functional controls for user interface, charging control, system configuration, diagnostics and payment processing. The functions of each of these controls are as follows.

| Control | Function |
|---|---|
| User Interface | Display operating instructions, monitor user |
| | inputs, display advertisements |
| Charging Control | Control charge contactors, monitor/control J1772 |
| | pilot, monitor safety systems |
| System Configuration | Configuration of system options: payment |
| | rate, advertisements, network set-up |
| Diagnostics | Monitor system health, report problems to central |
| | monitoring |
| Payment Processing | Process card data, request payment authorization, |
| | track payment data. |

Each control further includes a set of system requirements or functions as follows:

### User Interface

The Station shall display operation instructions, status information, and transaction feedback to
the user on an LCD screen.
The Station shall receive user inputs from a touch panel.
The Station shall display a message to the user indicating that a vehicle is not connected if no
connection is detected by the Station.
The Station shall display to the user a list of time periods for charging and the corresponding
costs for each time period.
The Station shall prompt the user to select a time period for charging.
The Station shall prompt the user to swipe a credit card if configured to require payment.
The Station shall prompt the user to swipe an access card if configured to require access.
The Station shall display a message to the user if credit card authorization has failed.
The Station shall display a message to the user when charging begins.
The Station shall provide means to display the remaining charging time for each active circuit.
The time display may be graphical and/or numerical.
The Station shall display advertisements that consist of images and video.
The Station shall display a message to the user if the access card authorization has failed.
The Station shall display a message to the user to indicate when the charging time has expired.
The Station shall display a message when the charging station is disabled.

### Charging Control

Control Pilot

The control pilot circuit ensures proper operation when connecting the Station to an Electric
Vehicle/Plug-in Electric Vehicle.
The Station has two independent control pilot circuits.
The Station shall be capable of handling all control pilot functionality for up to two independent
vehicles simultaneously.
The Station shall measure the voltage at the control pilot circuit to determine if the connector is
inserted in the vehicle and if the vehicle is able to begin charging. The vehicle state is defined
according to Table 3 of the SAE J1772 Specification.
The Station shall indicate that it is not ready to supply energy by transmitting a static voltage
signal defined by Table 4 of the SAE J1772 Specification.
The Station shall indicate that it is ready to supply energy by transmitting a PWM oscillator
signal defined by Table 4 of the SAE J1772 Specification.
The Station shall not transmit the oscillator signal until the user has selected a time period to
enable charging.
If the Station has been configured to require access card approval, it shall not transmit the
oscillator signal until the user's authorization has been confirmed.
If the Station has been configured to require the user to pay to activate charging, it shall not
transmit the oscillator signal until a credit card payment has been processed.
The Station shall communicate the maximum available continuous current capacity to the
EV/PHEV by modulating the control pilot duty cycle according to Tables 6A and 6B of the SAE
J1772 Specification.
If the vehicle state transitions to “Vehicle not connected” from any other state the Station shall
turn off the oscillator signal within a period of time defined by SAE J1772 Table 8.

Control Pilot Chart

The Station shall control the AC contactors to enable or disable the supply of energy.
The Station shall be capable of handling all contactor control functionality for up to two
independent vehicles simultaneously.
The Station shall monitor feedback from the AC contactors (if available).
The Station shall close the AC contactor if the oscillator signal is currently enabled and the
vehicle state indicates that the EV/PHEV is ready to accept energy as defined in SAE J1772
Table 3.
The Station shall close the AC contactor within the time defined by SAE J1772 Table 8
Transition 5 when the EV/PHEV indicates that it is ready to accept energy.
The Station shall open the AC contactor within the time defined by SAE J1772 Table 8
Transition 6 if the contactor is closed the EV/PHEV indicates it is not ready to accept energy.
The Station shall open the AC contactor within the time defined by SAE J1772 Table 8
Transition 8 if the contactor is closed and the Station experiences a condition that requires
termination of the energy transfer.
The Station shall open the AC contactor after the user-selected charging time period has elapsed.

Power Monitoring

The Station shall measure the current for each charging circuit.
The Station shall calculate the instantaneous power for each changing
circuit.
The Station shall calculate the energy supplied by each charging circuit
from the start of charging until the present time.
The Station shall measure the charge circuit interrupt device (CCID)
leakage current.
The calculated power for each charging circuit shall be available for the
central monitoring function.
The calculated energy for each charging circuit shall be available for the
central monitoring function.

System Configuration

The Station shall turn off the display if no user input is detected for at least a period of
predetermined minutes
The Station shall turn on the internal fan if the display temperatures exceeds 80 degrees C.
The Station shall turn off the internal fan if the fan is on and the display temperature drops below
75 degrees C.
The Station LCD backlight brightness shall have a configurable level based on the ambient light
sensor.
If the selected LCD allows viewing with the backlight off, the backlight will be turned off based
on a configurable option and the ambient light sensor.
The Station shall provide a system configuration mode for a station operator to change the
configuration of the Station.
The system configuration mode shall provide an option to enter the price per hour of charging.
The system configuration mode shall provide and option to modify network settings.
The system configuration mode shall provide an option to select between free public charging,
access card authorization for charging, and credit card authorization for charging
The system configuration mode shall provide an option to display the current status of diagnostic
functions.
The system configuration mode shall allow the charging station to be disabled manually or based
on a schedule.
All system configuration options shall be modifiable via a remote interface.

### Diagnostics and Central Monitoring

The Station shall provide periodic updates to a central monitoring service
regarding the functional status of the Station.
The status of all fault monitors shall be transmitted to the central
monitoring service as part of the status update.
The Station shall respond to a request by the central monitoring service for
a status update.

### Payment Processing

Card Reader

The Station shall monitor the card reader to determine if a card has been
swiped and information from the magnetic stripe has been obtained.
The Station shall distinguish between the type of information obtained by
the card reader, whether it is a credit card, access card, or an
incompatible card.
The Station shall store approved access card information in memory.
The Station shall have a service mode where an access card can be
swiped and the card information can be stored as an approved card.
The Station shall not decrypt any encrypted credit card information
including account number, names, and any other data obtained by
the card reader.

### Credit Card Processing

Card Reader

The Station shall transmit credit card information to a third-party credit
card processor for payment approval.
The Station shall retry transmission of credit card information for
payment approval X times if the initial transmission fails.

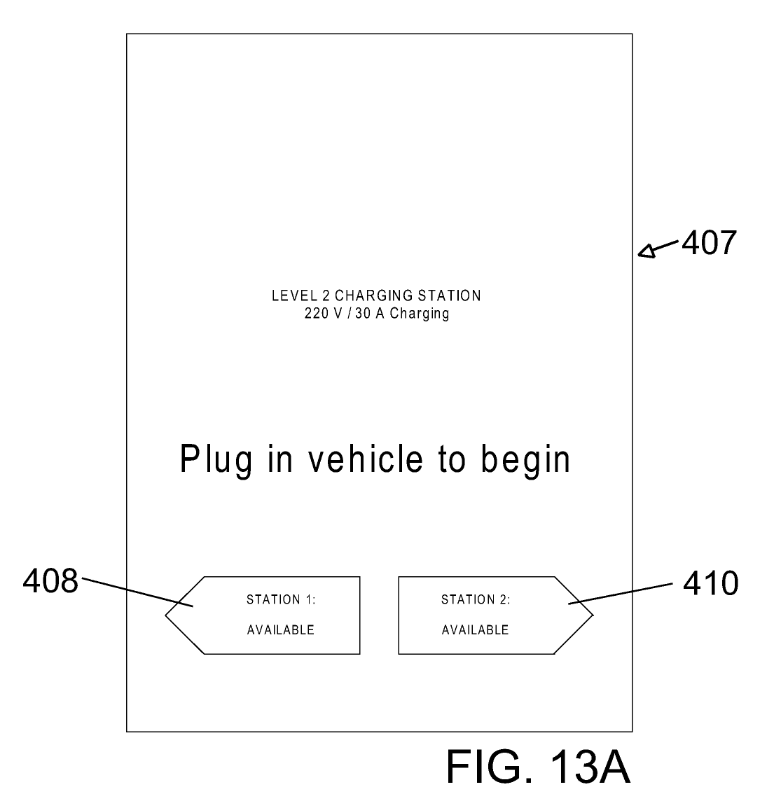

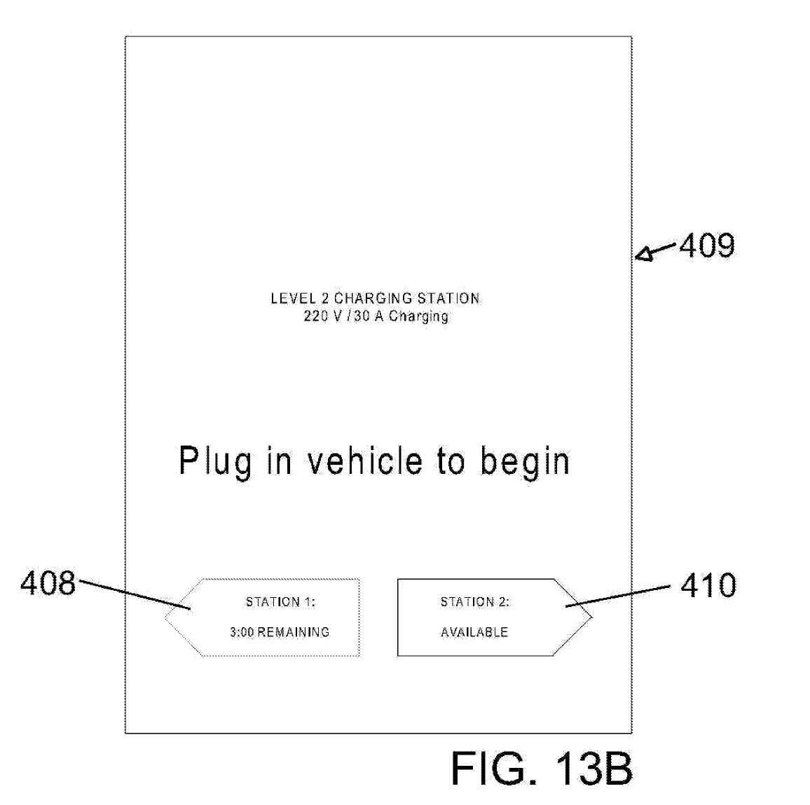

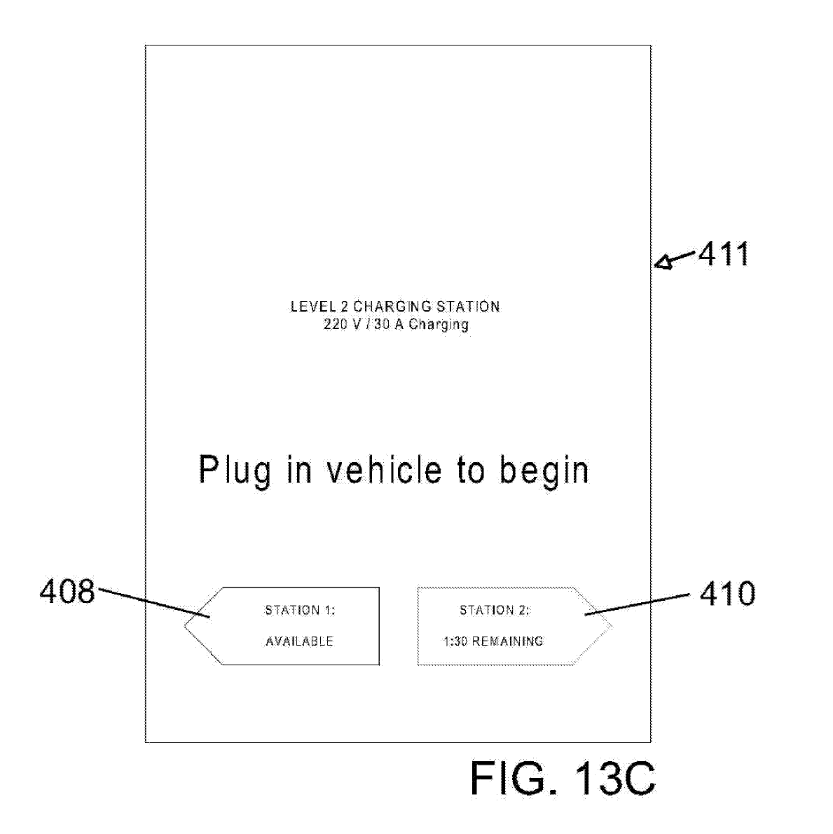

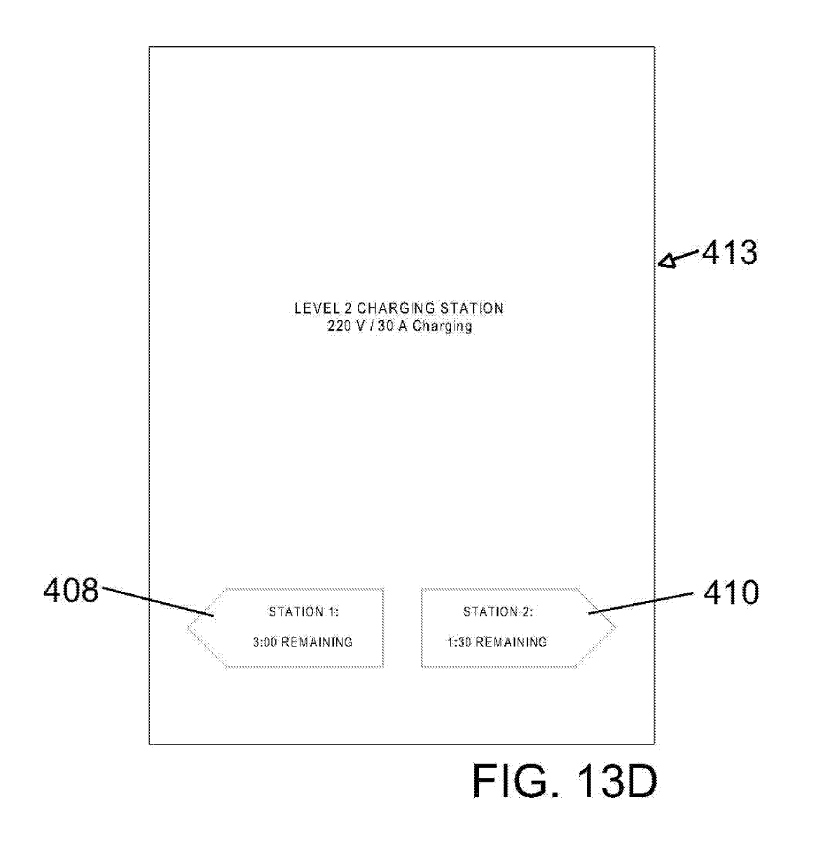

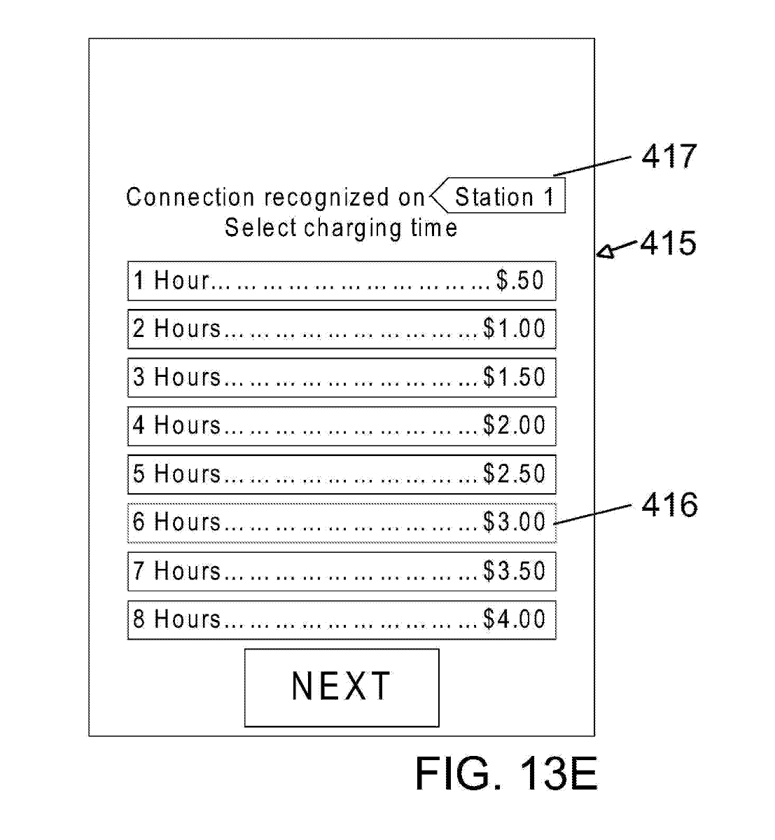

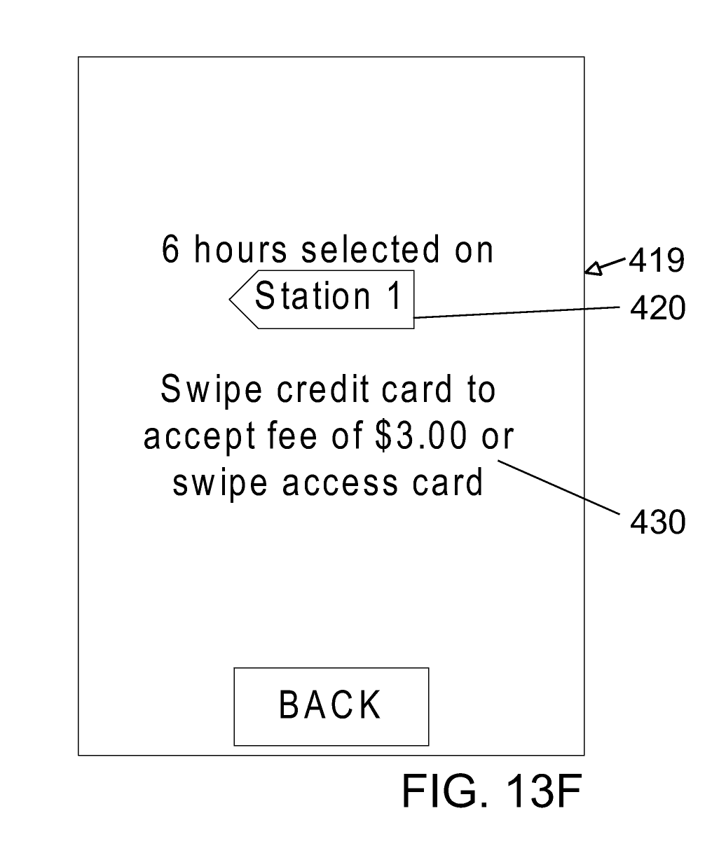

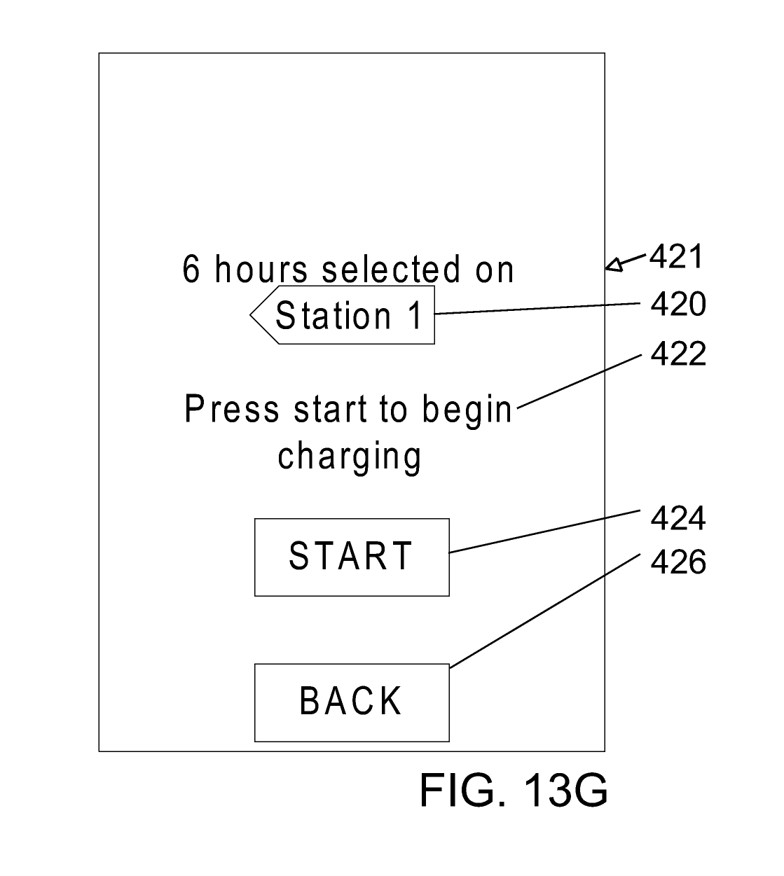

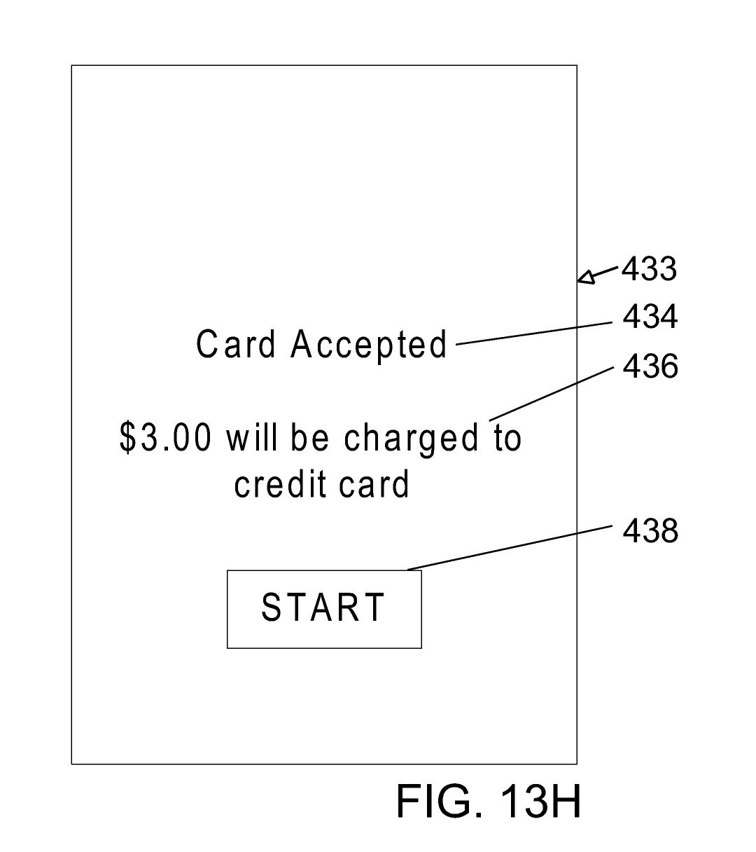

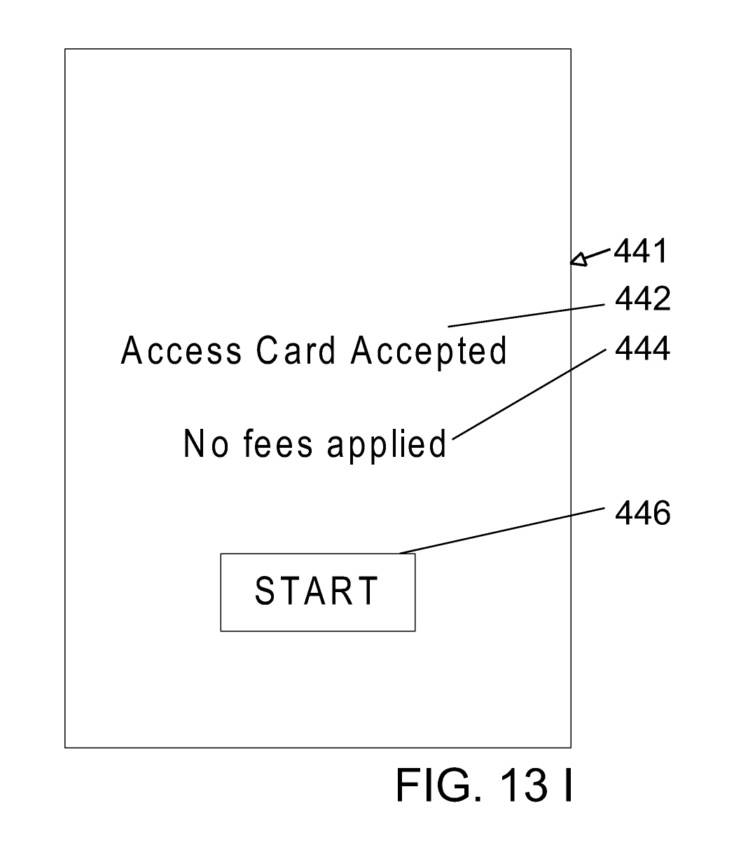

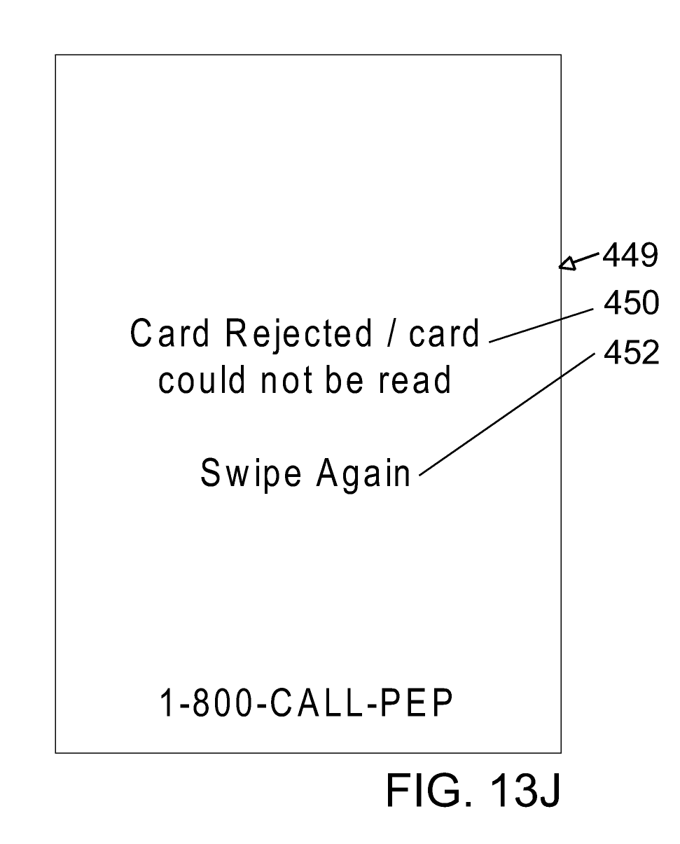

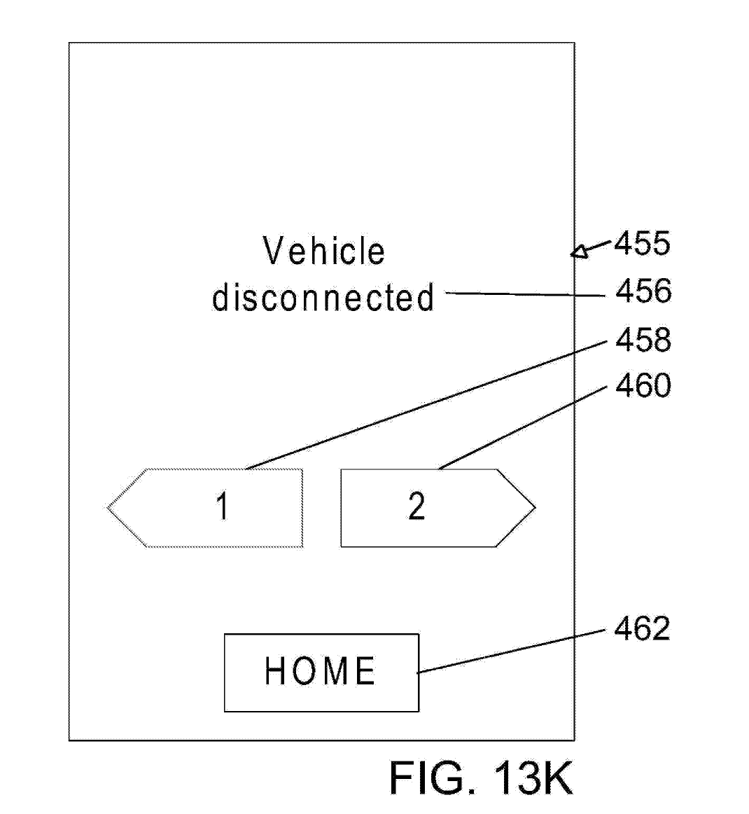

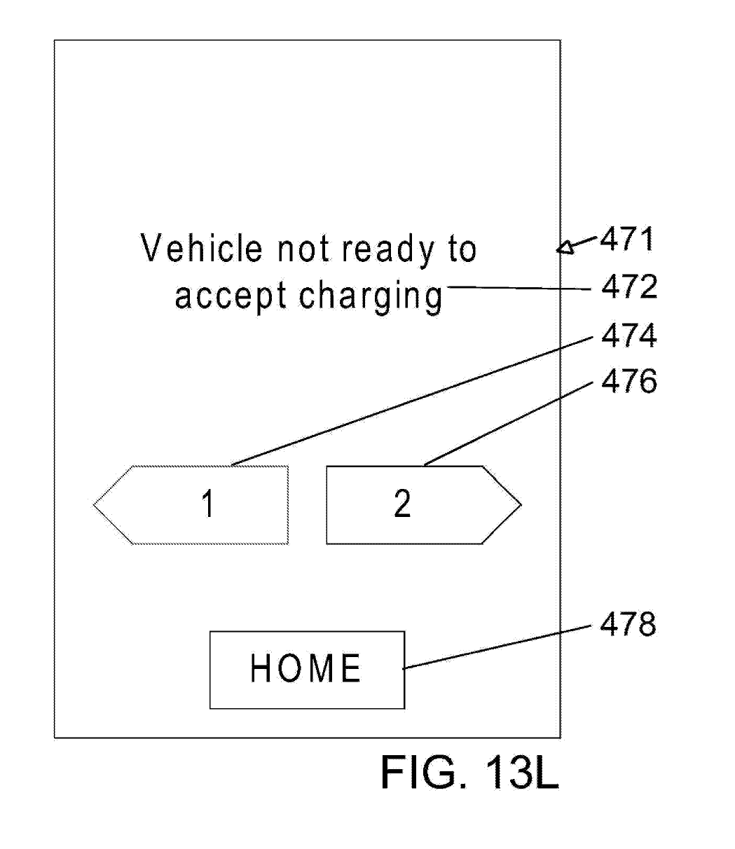

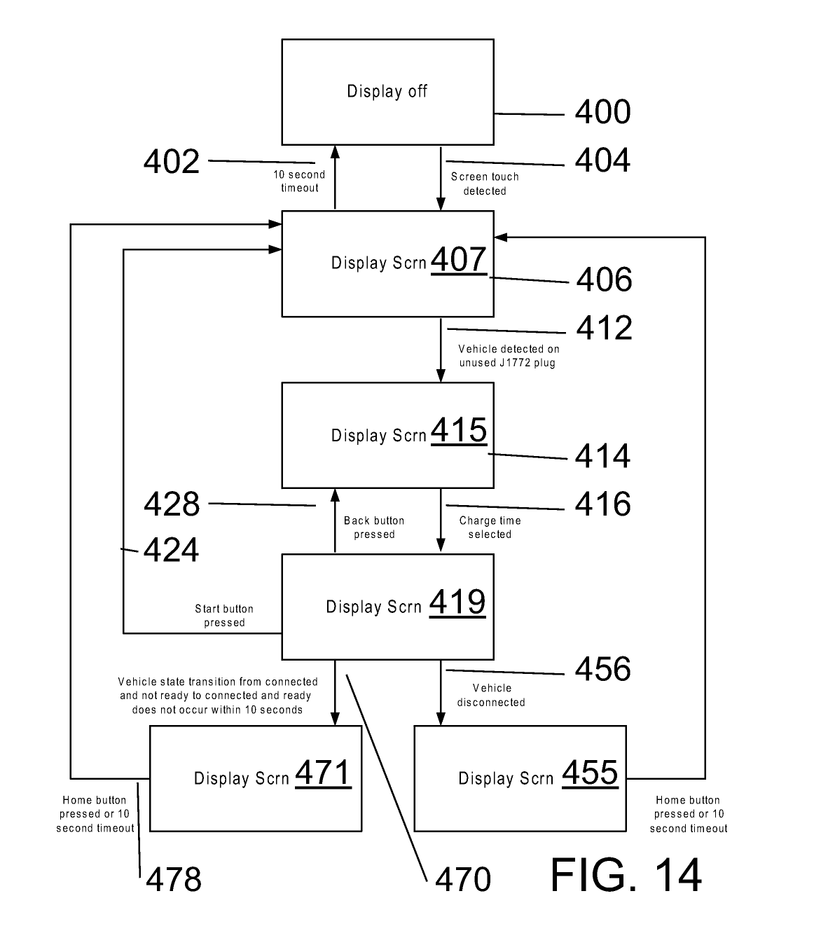

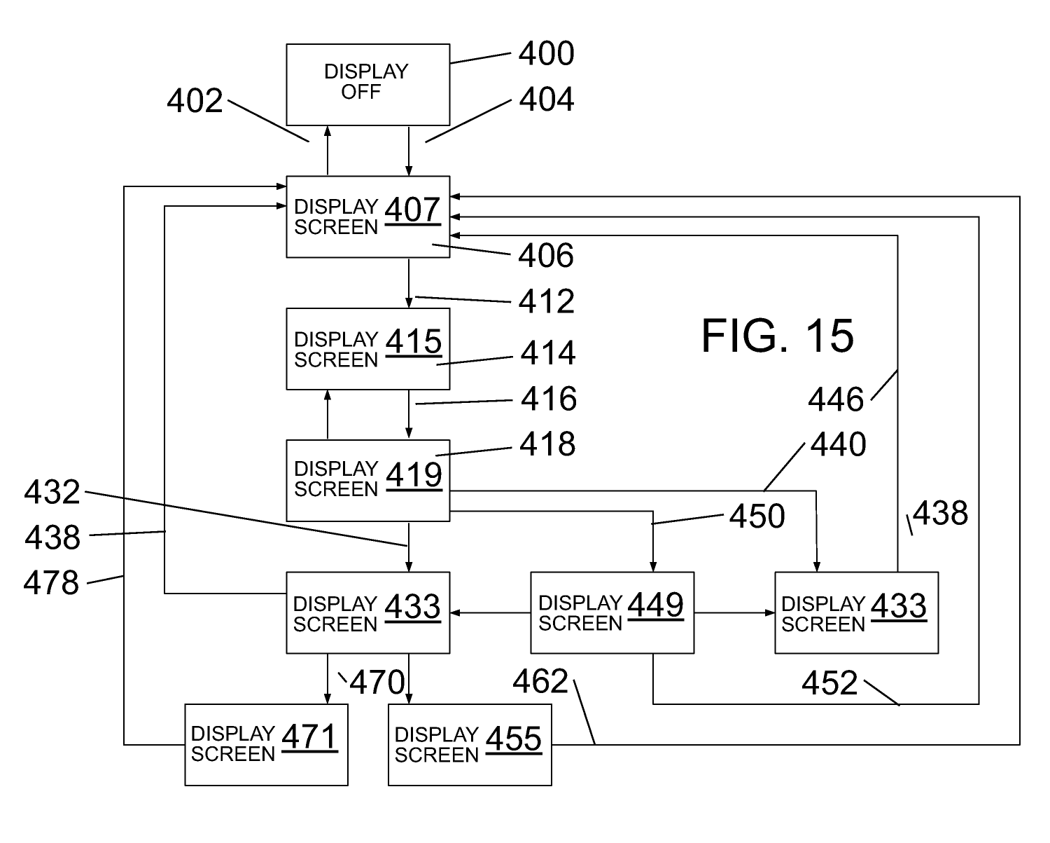

FIGS. 13A-13L depicts user interface screens, respectively, which are displayed by the CPU 100 on the display 80 of the vehicle recharge station 220 described above. The interface screens depict the various modes of user interaction with the recharge station 220. The various screens will be described in conjunction with the operation flowcharts shown in FIGS. 14 and 15.

FIGS. 14 and 15 are flow charts depicting the operation of the software program executed by the CPU 100 in various modes of operation, such as an unrestricted mode shown in FIG. 14, and an access card/credit card mode shown in FIG. 15. In each mode of operation, the CPU 100 will turn the display 80 off, step 400, when there has not been any activity at the recharge station for a set period of time, step 402. Any screen touch, step 404, by a user is detected by the display 80 and causes the CPU 100 to begin to execute the operational mode it has been preprogrammed to operate.

For example, in the unrestricted mode of operation shown in FIG. 14, once a screen touch is detected, the CPU 100 causes the appropriate screen, step 406, to be displayed on the display 80. Screen 407 in FIG. 13A provides station availability, station time remaining and instructions to a user of the recharge station.

The screen 407 provides a “Plug in vehicle to begin” instruction to the user. Two windows 408 and 410 are provided on the screen 407 and respectively describe the status of stations of 1 and 2 in the recharge station 20. In the example shown in the screen 407, both stations 1 and 2 are depicted in the windows 408 and 410, respectively, as being available for a plug-in connection between a vehicle and the recharge station.

Depending on the status of the recharge station and whether or not a vehicle is connected by a plug to one of the recharge station outlets, the user interface will depict in windows 408 and 410 the status of each station and the time remaining in the current recharge period selected by the user. For example, screen 409 in FIG. 13B shows 3 minutes remaining in the recharge time in station 1. Station 2 is depicted available for a plug connection. Similarly, in screen 411 shown in FIG. 13C, a station 2 has 1:30 minutes in the selected recharge time for the vehicle connected to station 2. Station 1 is illustrated in window 408 as being available for connection.

In screen 413 shown in FIG. 13D, both stations 1 and 2 show in windows 408 and 410 that vehicles are connected to each station with the recharge cycle times remaining depicted in each window 408 and 410.

It should be noted that the recharge station automatically detects the connection of a plug, such as a J1772 plug, to one of the outlets or stations 1 and 2 of the recharge station 20. As soon as this connection is detected in step 412, the CPU 100 switches the user interface to screen 415, step 414, as shown in FIG. 13 E.

The screen 415 depicts the connection of a vehicle plug to station 1 in window 417 and displays various available recharge times and the charge or rate for each selected time. One to eight hour increments have been provided, by example only, as selectable recharge times in the screen; different hour or minute or day increments may also be provided along with different rates.

If the user desires a six-hour recharge increment 416, the user merely touches the display screen 80 on the 6-hour window to input his selection to the CPU 100. Program flow continues automatically to screen 419 in FIG. 13F in step 416 in the unrestricted mode of operation or to step 418 in the access card/credit card mode of operation.

As shown in the screens depicted in FIGS. 13F and 13G, respectively, the recharge time increment 416 selected by the user is depicted on the screen along with the station, such as station 1, for example, in window 420 on the display indicating the station on the recharge station to which the vehicle is connected. The CPU 100 generates a message 422 to the user to “Press start to begin charging.” A start window 424 is provided on the display. Another window 426 is provided with a legend “back” to cause program flow to revert to the screen 415 in step 428.

The start command shown in window 424 is provided only in the unrestricted mode of operation since this mode does not require payment from the user. As shown in FIG. 14, once the start button 424 has been pressed, control flows back to the screen 407 in FIG. 13A where window 408 will depict the total time remaining in the selected recharge time period for station 1.

As shown in FIG. 15, after the user has selected a recharge time increment, such as a six-hour increment shown in window 416 in screen 415 in FIG. 13E, in the access card/credit card mode of operation, the CPU 100 switches program flow to screen 419, FIG. 13F in step 418 The screen 419 includes a window 420 indicating the station to which the vehicle is connected as well as the recharge time increment selected by the user. CPU 100 then generates a message 430 requesting the user to “Swipe credit card to accept fee of $3.00 or swipe access card”

Once the user swipes the credit card or access card, the CPU 100 through the card reader 80 authenticates the card and any required payment. If the swiped card is accepted and approved in step 432, FIG. 15, the CPU 100 generates screen 433 shown in FIG. 13H which displays a message “Card Accepted” in step 434 as well as an indication of the amount to be charged to the user's credit card in step 436. A start window 438 is provided in screen 433 and, when touched by the user, causes the CPU 100 to revert control back to screen 1 to indicate the total time remaining in the station to which the vehicle is connected.

The CPU generates screen 441, FIG. 13I in step 440 where an access card has been used. The CPU 100 generates a “Access Card Accepted” message in step 442 on the display 90 and a message “No fees applied” in step 444. A start window 446 is provided and, when touched by the user, causes the CPU 100 to revert control back to screens shown in FIGS. 13A-13D where the time remaining in the selected recharge time period is displayed in the appropriate station window 408.

The CPU 100 can generate a “Card Rejected/card could not be read” message in step 450, shown in the screen 449 in FIG. 13J and asks the user in step 452 to swipe the credit card or access card again. Control flows back to screen 433 FIG. 13H in the case of a credit card or to screen 441, FIG. 13I in the case of an access card. If the card is again rejected or the inactivity time period, such as 10 seconds, times out ins step 452, control reverts back to the screen 407 in FIG. 13A.

Once the start button 438 in screen 433 or the start button 446 inc screen 441 is touched, the CPU 100 causes program power or changes to be supplied to the vehicle. If the user disconnects the plug from the station, the CPU 100 generates a “Vehicle disconnected message” 456 in screen 455, FIG. 13 K and highlights one of two station windows 458 and 460, such as station 1 in the present example, to indicate which station has been disconnected. A “home” window 462 is provided for the user to cause program control to revert back to one of screens 407, 409, 411 or 413.

The CPU 100 also automatically verifies that the vehicle connection state transitions from “connected and not ready” to “connected and ready” within a preset time period, such as ten seconds, in step 470. Screen 471, FIG. 13L is similar to screen 455 except that the CPU 100 generates a message “Vehicle not ready to accept charging”. One of the station windows 474 and 476 is highlighted, such as the station 1 window 474 in the present example, to indicate which station is not ready to accept charging. A home window 478 is provided for the user to touch to revert program control back to screens 407, 409, 411 or 413. Program control can also revert automatically through the CPU 100 in step 478 back to screens 407, 409, 411 or 413 if the home button 478 is not touched within a preset time period, such as 10 seconds.

The vehicle-disconnected sequence 456 in the screens 455 and 471 described above for the access card/credit card mode of operation also applies to the unrestricted mode of operation.

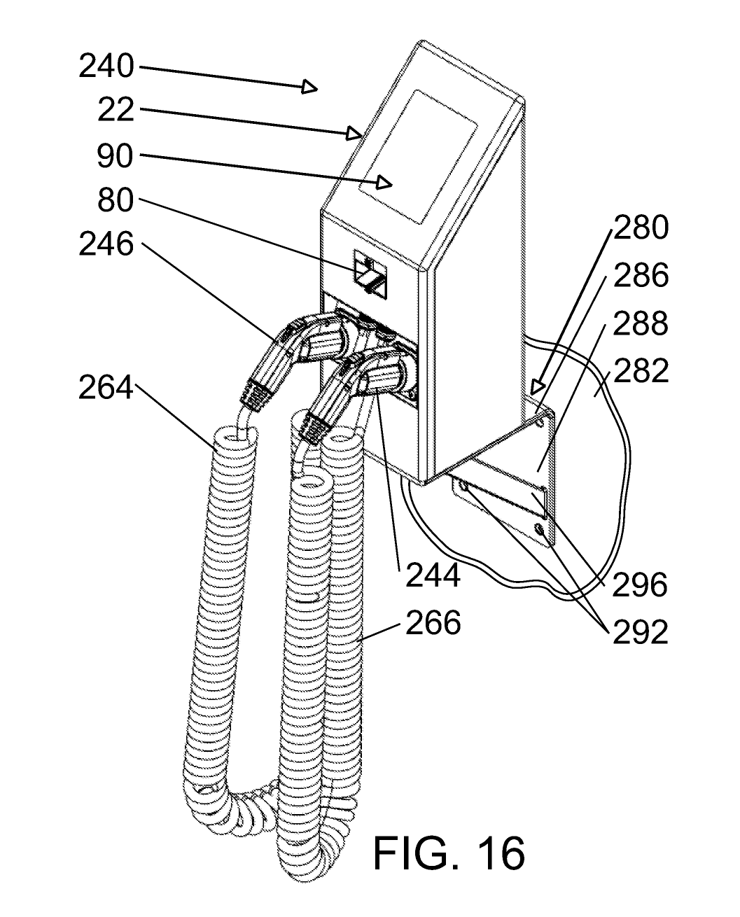

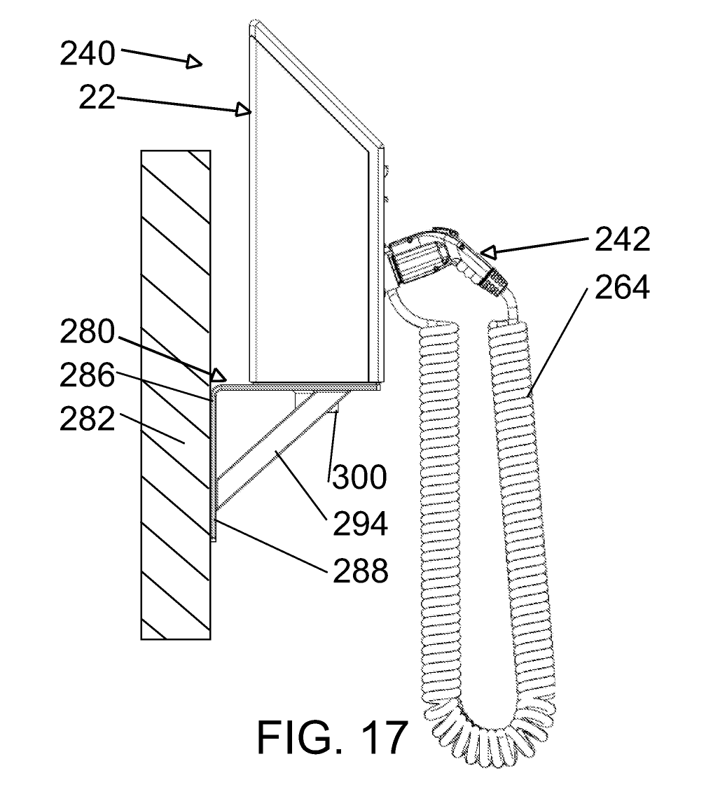

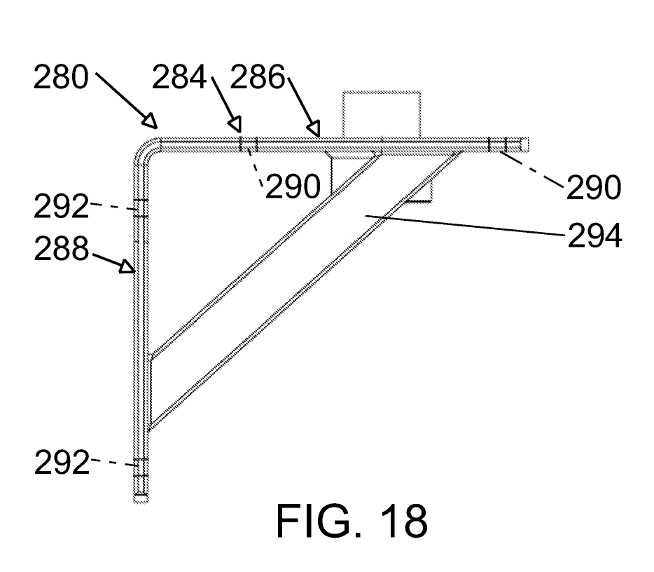

A mounting bracket 280 maybe employed for mounting the housing 22 shown in FIG. 1 of a recharge station 240 in a spaced position from a wall or mounting surface 282, as shown in FIGS. 16-19.

The wall mounting bracket 280 includes a mounting panel 284 formed of an upper, generally horizontally extending surface 286 and a rear, generally vertically extending surface 288. The mounting panel 284 may be integrally formed as a one piece assembly with the mounting surfaces 286 and 288 bent into the desired orientation, or the mounting panel 284 may be formed of separate members, each forming the mounting surfaces 286 and 288 which are fixedly joined along a common edge.

A plurality of mounting apertures, such as four mounting apertures 290, by example only, are formed in the mounting surface 286. The four inner mounting apertures 44 in the mounting plate 42, see FIG. 9A. are positioned to receive mounting fasteners extended through the apertures 290 in the wall mount bracket to affix the housing 22 to the mounting surface 286.

An arcuate or curved slot 49 is also formed in the mounting plate 42. The slot 49 is provided to receive a communication cable, such as Ethernet cable, for the wall mounted recharge station 240 as shown in FIG. 16. The curved and enlarged length of the slot 49 enables the wall mounted housing 22 to be rotated 90° from a normal use position to allow access to the rear portion of the housing 22 for removal of the rear outer cover 218, as described above, to provide access to the interior components of the housing 22. The elongated nature of the slot 49 enables the stationarily fixed communication cable to remain in place during rotation of the housing 22.

Similarly, a plurality of mounting apertures 292 are formed in the mounting surface 288. Four mounting apertures 292 are shown by way of example only in the mounting surface 288. Separate fasteners are extendable through the apertures 292 to secure the rear mounting surface 288 and the entire mounting bracket 280 to a wall or other suitable mounting surface 282.

A pair of support ribs 294 and 296 is joined at opposite ends to the upper mounting surface 286 and the rear mounting surface 288 to stabilize the mounting bracket 280.

A large half couple connector 300 is fixed to the upper mounting surface 286, such as by welding. A conduit stub 302 is fixed to the connector 300 and extends through an aperture formed in the upper mounting surface 286 and into a complementary aperture in the bottom wall of the housing 22. The half couple connector 300 and the conduit stub 302 provide an entry path for power conductors from a utility or building power supply network to the power connections within the interior of the housing 22 of the recharge station 240.

Similarly, a smaller half couple 304 is fixed, such as by welding, to the upper mounting surface 286. The half couple 304 is located adjacent to the half couple 300. A small pipe stub 306 is fixed at one end to the half couple 304 or to the upper mounting surface 286 and extends through the upper mounting surface 286. The half couple 304 and pipe stub 306 and into complementary aperture in the bottom wall of the housing 22 to provide an entry passage for external communication network cables and conductors, such as a Ethernet cable, to the interior of the housing 22.

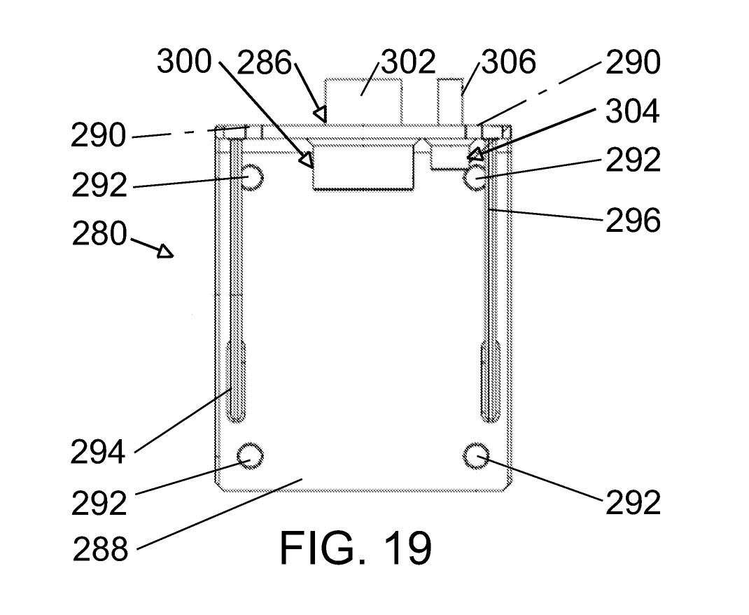

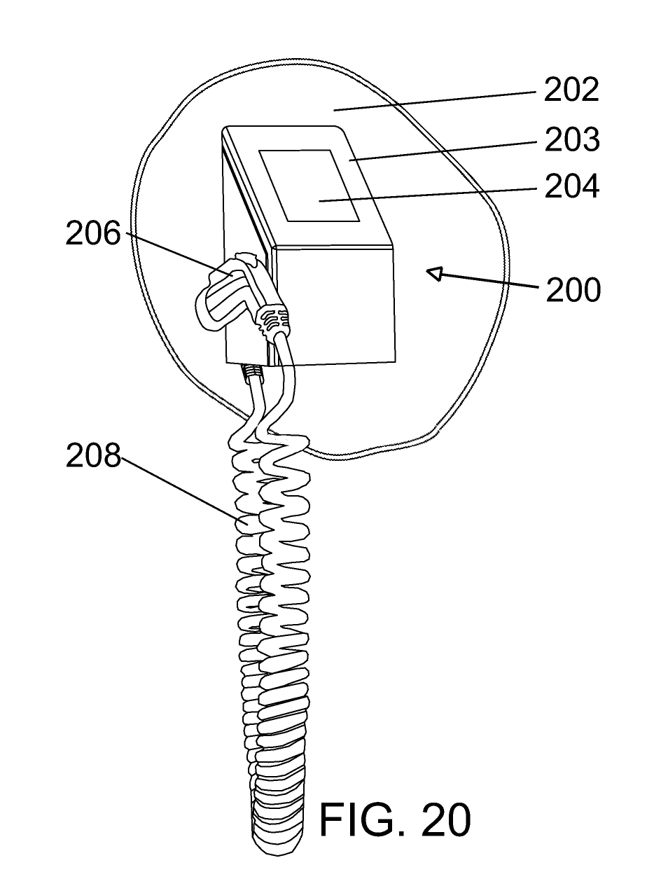

Referring now to FIG. 20, there is depicted a home vehicle recharge station 200, which is mounted on a wall 202 of a garage. The recharge station 200 is similar to the recharge station 20 shown in FIG. 9, and includes essentially the same components as the recharge station 170, namely, a display 90, and optional remote internet connection, etc. A card reader 80 will typically not be required in a recharge station 200 since it is assumed that the user will be the owner of the home and is therefore authorized to use the recharge station 200. However, it can be included to provide access card verification.

In addition, the display 204 may only need to display a minimal amount of information, without advertising, rate price information, etc., as in the previously described aspects of the recharge station. Rather, the display 204 may only need to allow the input of a user security or access code to turn the recharge station 200 on and off. The access code can be input through the touch display screen 204, for example.

Attachments can be provided in the housing 203 to enable mounting of the entire housing 203 to the garage wall 202. The attachments can be external or internal to the housing 203 and maybe apertures in the rear wall of the housing 203 which receive mounting fasteners, or flanges extending outward from the garage wall.

In most applications, the home recharge station 200 will be provided with a single J1772 plug 206 which is coupled to the internal circuitry of the recharge station 200 by a coiled cord 208. The J1772 plug 206 can optionally be removably mounted on one side of the housing of the recharge station 200 by a suitably positioned clip or receiver on the housing 203 of the recharge station 200. Alternatively, the plug 206 can be mounted on the front wall of the housing 203 as in station 20.

The recharge station 200 will typically be employed to supply 220 VAC power to a vehicle through the use of the J1772 plug 206. Electrical code will require that the recharge station 200 be electrically hardwired to the electrical service of the home or garage, such as by a direct wire connection to a circuit breaker. The 220/240 VAC conductors from the home circuit box can enter the housing 203 of the recharge station 200 through an opening in the rear wall of the housing 203 or via a conduit extending along the garage wall 202 to a suitable entry aperture in the housing 200, such as on any of the rear, bottom or side walls of the housing 203.

It is also envisioned that the recharge station 200 can be provided with two J1772 plugs 206, one on each side or in the front of the housing 203, in the event the home owner wishes to have the capability to simultaneously recharge two vehicles from the single recharge station 200.

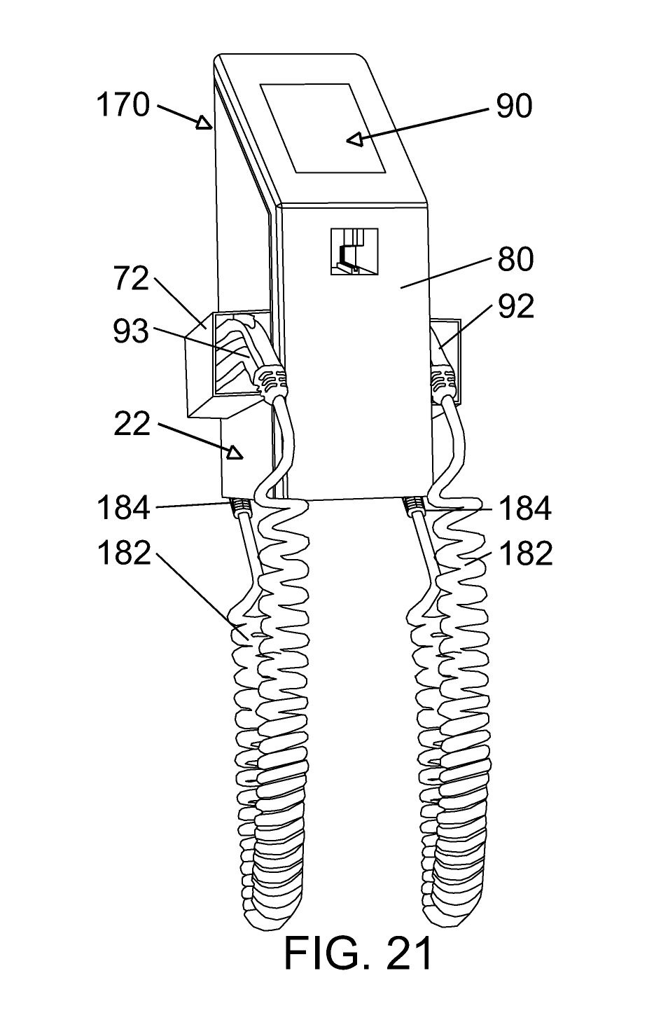

Referring now to FIG. 21 there is depicted another aspect of the vehicle recharge station in which the recharge station 170 is constructed as a wall or pedestal mount recharge station which can be mounted on walls, such as parking garage walls, residential home garage walls, building walls, fence walls, etc, adjacent any vehicle parking space

Wall attachments are provided on the housing 22 to enable mounting of the entire housing 22 to a wall. The attachments can be external or internal to the housing 22 and may include apertures which receive fasteners, such as screws, anchors, etc.

For simplicity, the wall mounted recharge station 170 is illustrated as including the same housing 22, card reader 80 and display 90 as described previously and shown in FIG. 1 for the recharge station 20.

A pair of plug mounts 172 and 174 is provided on the housing 22. Each mount 172 and 174 maybe a separate member affixed, such as by mechanical fasteners, welding, etc., to short flanges extending out from and formed as a integral part of the back wall of the housing 22; or as separate members fixed to the sidewalls of the housing 22 again, by welds, mechanical fasteners, etc.

The J1772 plugs 92 or 93 are used to provide 220/240 VAC power to vehicles. In this application, the 220V/240V power from a building power source can be supplied via hard conductors to the housing 22 through an aperture in the rear wall of the housing 22 or via a conduit which enters the housing 22 through the bottom walls or one of the side walls of the housing 22.

For example, each mount 172 and 174 may be generally tubular shaped body 176 with an open end 178. The body 176 maybe completely hollow or may include an internal bores, which snugly receive the pins of the J1772 plug 92 or 93.

Each J1772 plug 92 and 93 has an extensible cord, such as a coil cord 182, extending from a first end connection to one end of the handle assembly of the J1772 plug 92 and 93 through a stress relief 184 on the bottom wall of the housing 22. The internal conductors in the cords 182 extend through the stress relief 184 to connections within the housing 22.

Although the various aspects of the vehicle recharge station 20, described above, show the J1772 plugs as being mounted in a recessed panel 246 on the front wall 60 of the housing 22 or on the side of the housing 22 in FIG. 21, such mounting positions are by way of example only. The recharge station 20 may also be configured to have one or more J1772 plugs mounted on one or more of the sidewall 62 and 66 and/or the rear wall 64 of the housing 22.

In addition, more than two J1772 plugs may be incorporated into a single housing 20. In such a configuration, one or more J1772 plugs could be mounted on the front wall 60 of the housing 22 as shown in FIG. 1 with additional J1772 plugs mounted in the similar manner or the side walls 62 or 66 and/or the rear wall 64 of the housing 20, or even in an enlarged recessed panel 246 on the front wall 60.

1. An electric vehicle recharge apparatus comprising:
a housing;
at least one electrical plug provided on the housing and connected to a supply of electric power; and
a concrete pedestal mounted in the ground and supporting the housing.

2. The apparatus of claim 1 wherein:
the concrete pedestal includes first and second ends, the first end disposed within the ground and the second end disposed above ground surface.

3. The apparatus of claim 2 further comprising:
a first plate fixed on a lower end portion of the housing, the first plate secured to the second end of the pedestal to mount the housing on the pedestal.

4. The apparatus of claim 3 further comprising:
the first plate including a first aperture; and
a bore extending through the concrete pedestal to the second end and aligned with the first aperture in the first plate to provide a passage for electrical conductors through the pedestal to the housing.

5. The apparatus of claim 3 further comprising:
the first plate including a plurality of mounting apertures;
rods fixed within the concrete pedestal and having a threaded end projecting above the second end of the pedestal; and
the threaded end of the rods insertable through mounting apertures in the first plate and adapted for receiving fasteners to secure the plate and the attached housing to the second end of the pedestal.

6. The apparatus of claim 2 further comprising:
the concrete pedestal having an angled peripheral surface extending from the second end to exterior sides of the pedestal.

7. The apparatus of claim 3 further comprising:
a seal gasket mounted between the first plate and the second end of the pedestal.

8. The apparatus of claim 1 wherein:
the at least one electrical plug on the housing is a J1772 plug.

9. (canceled)

10. The apparatus of claim 1 further comprising:
a switchable outlet in the housing coupled to the supply of electrical power; and
a coiled electrical cable having one end coupled to the switchable outlet and an opposite end coupled to the plug to enable extensive movement of the plug from a holder on the housing to an electrical power connector port on an electric vehicle.

11. The apparatus of claim 1 wherein:
the at least one electrical plug is two J1772 plugs.

12. (canceled)

13. The apparatus of claim 1 further comprising:
a panel recessed from a major plane of a front wall of the housing; and
a holder carried on the panel temporarily receiving the at least one electric plug in a non-use mounting position on the housing.

14. The apparatus of claim 1 further comprising:
an interactive display mounted in the housing for providing customer instructions with respect to an electric power charging sequence, the instructions providing user selection of the number of hours of electric power charge to be supplied to a vehicle;

15. (canceled)

16. (canceled)

17. The apparatus of claim 1 further comprising:
a card reader mounted in the housing and coupled to a central processor unit in the housing for obtaining customer identification prior to authorizing the supply of electric power to the vehicle; and
the card reader coupled to a remote card processing network for authorizing the supply of electric power from the housing by a user.

18. An electric vehicle recharge apparatus comprising:
a housing;
at least one electrical outlet provided in the housing and connected to a 208-240V AC supply of electric power;
at least one switchable J1772 plug removably connectable to an electric vehicle; and
a coiled electrical cord coupling the J1772 plug to the outlet in the housing.

19. (canceled)

20. The apparatus of claim 18 wherein:
the at least one outlet comprises two outlets mounted on the housing;
a distinct J1772 plug coupled to each outlet and
a separate coiled conductor connecting each J1172 plug to one outlet.

21. (canceled)

22. (canceled)

23. (canceled)

24. (canceled)

25. The apparatus of claim 1 further comprising:
a support mountable to a wall and to the housing for supporting the housing on the wall.

26. (canceled)

27. (canceled)

28. (canceled)

29. A method, implemented on a machine, for controlling the supply of electric power to a vehicle via a plug-in connection, the method comprising the steps of:
providing an electric power control device coupled to a source of electric power;
providing at least one power outlet on the electric power control device electrically connected to a connector adapted for electrical connection to an electric rechargeable vehicle;
providing a visual user interface operated by the control device to display instructions to the user for connecting a plug to the at least one outlet and for validating a user's access to electric power through the control device, the user interface including:
requesting the user to connect a plug from a vehicle to the at least one outlet;
offering selectable electric power supply time increments to the user;
accepting a time increment selected by the user;
validating the user's access to the selected supply time increment;
connecting electric power from the electric power source through the control device, the outlet and the plug to the vehicle for the duration of the selected supply time increment; and
discontinuing the supply of electric power to the vehicle at the end of the selected supply time increment.

30. (canceled)

31. The method of claim 29 wherein the step of authorizing payment comprises:
providing a card reader coupled to the control device;
inserting one of a credit card and an access card by the user to the card reader; and
validating the card.

32. (canceled)

33. The method of claim 31 further comprising the step of:
providing a touch selection screen for the customer to select one of a plurality of different recharge time periods.

34. (canceled)

35. (canceled)

36. (canceled)

37. (canceled)
